(19) United States
(12) Patent Application Publication
(10) Pub. No.: US 2007/0055836 A1
(43) Pub. Date: Mar. 8, 2007

(54) Information processing system, separation concealment apparatus, separation control method, and program

(75) Inventors: Junichi Yamato, Tokyo (JP); Masaki Kan, Tokyo (JP); Yoshihiro Kajiki, Tokyo (JP); Kengo Harada, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/516,515

(22) Filed: Sep. 7, 2006

(30) Foreign Application Priority Data
Sep. 8, 2005 (JP) 2005-260382

(51) Int. Cl. G06F 12/16

(52) U.S. Cl. 711/162

(57) ABSTRACT

A concealment apparatus is provided between a replication source storage and a replication destination storage, a separation between the replication source storage and the replication destination storage is replaced with a separation between the concealment apparatus and the replication destination storage and, thereby, the separation between the replication source storage and the replication destination storage is concealed from the replication source storage.

### FIELD OF THE INVENTION

The present invention relates to an information processing system, and more particularly to an information processing system with the replication function or the mirroring function, a control method, and a computer program.

### BACKGROUND OF THE INVENTION

Data replication, a function to create replica storage (also referred to as a duplicate volume) of master storage (also referred to as an enterprise volume or a master volume), is installed in a disk array device or a storage area network product. Replication is an operation that copies data from master storage to replica storage. For example, replication is used to copy the latest data (updated data) from master storage to replica storage that is used in a test environment or in a search operation. Separation is an operation to separate (disconnect) replication-source master storage from replication-destination replica storage. For example, separation is used to stop the copy of data between master storage and replica storage to allow the replica storage to be used in a test environment or in a search operation. During the separation time, replica storage is used in a test in a data warehouse or a system as a BCV (Business Continuance Volume). A storage system with the replication function for creating a separable duplicate volume, such as “iStorage series disk array device” (NEC corporation), is already developed and placed on the market.

For use when an error occurs in a line between master storage and replica storage or when the processing power of the replica storage is lower than that of the master storage, a forced separation function is also known to prevent an operation, which uses the master storage, from being affected.

When master storage is separated from replica storage in a practical operation, the master storage is used in an operation even during the separation. Therefore, after the master storage and the replica storage are reconnected, a mechanism is necessary for resynchronizing the master storage and the replica storage.

For data transfer in a storage system, see Patent Document 1.

[Patent Document 1] Japanese Patent Kokai Publication No. JP-P2000-305856A

### SUMMARY OF THE DISCLOSURE

When master storage and replica storage, which have been in the separation state during which data copy between them is stopped, are reconnected and resynchronized, a load is imposed on the master storage for resynchronization. In this case, if the load on the master storage to resynchronization is too high that the performance of the production operation is affected, there is a need to reduce the amount of processing for resynchronization. For this reason, resynchronization takes long.

Also in a mirroring system where the host writes data in multiple storage devices, it takes long to resynchronize the storage devices if they are in the separation state.

In view of the foregoing, it is an object of the present invention to provide an apparatus, a system, a method, and a program for reducing the time for resynchronization between master storage and replica storage that have been separated.

A separation concealment apparatus in accordance with one aspect of the present invention is provided on a transfer path between a data transfer source system and a data transfer destination storage system to perform processing for concealing a separation. The A separation concealment apparatus is adapted to replace a separation between the data transfer source system and the data transfer destination storage system with a separation between the separation concealment apparatus and the data transfer destination storage system to conceal from said data transfer source system that said data transfer source system and said transfer destination storage system are being separated.

The apparatus according to the present invention comprises a temporary storage device; and means for storing data, which is transferred from the data transfer source system to the transfer destination storage system during the separation, in the temporary storage device. The apparatus according to the present invention further comprises means for performing resynchronization by transferring the data, stored in the temporary storage device, to the data transfer destination storage system.

The apparatus according to the present invention further comprises means for performing resynchronization by transferring the data, stored in the temporary storage device, to the data transfer destination storage system to conceal from the data transfer source system that the data transfer destination storage system is performing resynchronization.

In the present invention, the data transfer source system, the separation concealment apparatus, and the data transfer destination storage system are connected in series. Alternatively, the data transfer source system writes the same data to multiple data transfer destination storage systems, with multiple separation concealment apparatuses connected between the data transfer source system and the multiple data transfer destination storage systems, one for each.

An apparatus in another aspect of the present invention, provided on a transfer path between a replication source storage system and a replication destination storage system, comprises a separation concealment apparatus that conceals the separation from the replication source storage system.

A system in one aspect of the present invention comprises a separation concealment apparatus, provided on a transfer path between a replication source storage system and a replication destination storage system, that performs processing for concealing a separation from the replication destination storage, wherein a separation between the replication source system and the replication destination system is replaced with a separation between the concealment apparatus and the replication destination system to conceal from the replication source system that the replication source system and the replication destination system are separated.

In the system according to the present invention, the separation concealment apparatus comprises a temporary storage device; and separation processing means for storing update information, which is transferred from the replication source storage to the replication destination storage, in the temporary storage device during the separation.

In the system according to the present invention, the separation processing means of the separation concealment apparatus may return a response to the replication source storage when the update information is stored in the temporary storage device.

In the system according to the present invention, the separation processing means of the concealment apparatus may store the update information, transferred from the replication source storage to the replication destination storage, as well as information indicating the arrival order, in the temporary storage device during the separation.

In the system according to the present invention, the separation concealment apparatus preferably further comprises resynchronization means for resynchronizing the replication destination storage during resynchronization time.

In the system according to the present invention, the resynchronization means transfers the update information, stored in the temporary storage device, to the replication destination storage during the resynchronization to resynchronize the replication destination storage with no need for the replication source storage to be involved in the resynchronization processing.

In the system according to the present invention, the resynchronization means may delete the update information from the temporary storage device after the update information, stored in the temporary storage device, is transferred to the replication destination storage during the resynchronization. Alternatively, a deletion flag may also be set.

In the system according to the present invention, the separation concealment apparatus may further comprise monitoring means for monitoring a storage amount of the temporary storage device during the resynchronization, wherein, when there is left no update information stored in the temporary storage device, it is determined that the resynchronization is completed and a transition to a normal state occurs.

In the system according to the present invention, the separation concealment apparatus may hold only the latest update information on the update of the same data block, which is included in the update information stored in the temporary storage device, but discard older update information.

In the system according to the present invention, when the separation concealment apparatus receives update information from the replication source storage during the resynchronization, the separation processing means may store the update information and information on an arrival order of the update information in the temporary storage device and return a response to the replication source storage.

In the system according to the present invention, the separation concealment apparatus may be configured in such a way that, during the resynchronization, an update request sent from the replication source storage is kept waiting to allow the update information, stored in the temporary storage device, to be completely transferred to the replication destination storage more quickly.

In the system according to the present invention, the separation concealment apparatus may be configured in such a way that update information sent from the replication source storage is not stored in the temporary storage device during the resynchronization but is transferred to the replication destination storage.

In the system according to the present invention, the separation concealment apparatus may be configured in such a way that the updates of the continuous data blocks, included in the update information stored in the temporary storage device, are combined into one piece of information for transfer to the replication destination storage.

In the system according to the present invention, the separation concealment apparatus may receive a control signal, which controls a separation, and perform a separation when the control signal indicates a separation.

In the system according to the present invention, the separation concealment apparatus may receive a control signal, which controls a resynchronization, and perform a resynchronization when the control signal indicates a resynchronization. The monitoring result of the network status, produced by the network monitoring device, is used as the control signal for controlling a separation. It is also possible that the replication source storage and the replication destination storage are forced to separate when a network error occurs and that the resynchronization processing is performed and the operation is recovered automatically to the normal replication when the network is recovered.

In a system (mirroring system) in accordance with another aspect of the present invention, an information processing system that performs mirroring, in which a host writes the same data in a plurality of storages, comprises a plurality of separation concealment apparatuses, each of which conceals a separation, between the host and associated one of the plurality of storages, wherein a separation between the host and the storage is replaced with a separation between the concealment apparatus and the storage to conceal from the host that the host and the storage are separated.

In the mirroring system according to the present invention, the separation concealment apparatus comprises a temporary storage device; and separation processing means that, upon receiving a write request to the storage and data from the host during the separation, stores the write request and the data in the temporary storage device.

In the mirroring system according to the present invention, the separation processing means of the separation concealment apparatus may return a response to the host when the update information is stored in the temporary storage device.

In the mirroring system according to the present invention, the separation processing means of the separation concealment apparatus may store a write request and data, transferred from the host to the storage, as well as information indicating the arrival order, in the temporary storage device during the separation.

In the mirroring system according to the present invention, the separation processing means of the separation concealment apparatus may return an error to the host in response to a read request from the host during the separation.

In the mirroring system according to the present invention, when a read request is received from the host during the separation, the separation processing means of the separation concealment apparatus may be configured in such a way that the separation processing means searches the temporary storage device to check if data specified by the read request is stored and, if the data specified by the read request is stored in the temporary storage device, returns the data, which is searched for, to the host and, if the data specified by the read request is not stored in the temporary storage device, returns an error to the host.

In the mirroring system according to the present invention, the separation concealment apparatus may sequentially issue a read request to multiple storages during the resynchronization in response to a read request from the host and, if an error is received from a separated storage or a timeout occurs, send a read request to the next storage.

In the mirroring system according to the present invention, when a read request is received from the host during resynchronization, the separation concealment apparatus may issue a read request to the plurality of storages and, when normal data and a response are received from one of the plurality of storages, determine that the read is completed.

In the mirroring system according to the present invention, when a read request is received from the host during resynchronization, the separation concealment apparatus may issue a read request to the plurality of storages, wait for the plurality of storages to return normal data and a response, compare data from the storages except those where an error or timeout occurred, to create correct data, and returns the created data to the host.

In the mirroring system according to the present invention, the resynchronization means may transfer a write request and data, stored in the temporary storage device, to the storage during resynchronization.

The resynchronization means may transfer a write request and data, stored in the temporary storage device, to the storage during resynchronization.

In the mirroring system according to the present invention, the separation concealment apparatus may further comprise means that monitors a storage amount of the temporary storage device during resynchronization. In this configuration, when there is left no update information stored in the temporary storage device during the resynchronization processing, the resynchronization is completed and the concealment apparatus moves to a normal state.

In the mirroring system according to the present invention, the separation concealment apparatus may hold only the latest update information on the update of the same data block, which is included in the update information stored in the temporary storage device, but discard older update information.

In the mirroring system according to the present invention, when the separation concealment apparatus receives a write request and data from the host during the resynchronization, the separation processing means may store the write request and data, as well as information on the arrival order, in the temporary storage device and return a response to the host.

In the mirroring system according to the present invention, the separation concealment apparatus may be configured in such a way that, during the resynchronization, a write request and data to be sent to the storage are kept waiting to allow the write request and data, stored in the temporary storage device, to be completely transferred to the storage, which is being resynchronized, more quickly.

In the mirroring system according to the present invention, it is also possible that a write request and data, sent from the host, are not stored in the temporary storage device during the resynchronization but are transferred to the replication destination storage.

In the mirroring system according to the present invention, the separation concealment apparatus may receive a control signal, which controls a separation, and perform a separation when the control signal indicates a separation. The concealment apparatus may receive a control signal, which controls a resynchronization, and perform a resynchronization when the control signal indicates a resynchronization.

In the mirroring system according to the present invention, the separation processing means of the separation concealment apparatus may be configured as follows. When a read request is received from the host during the separation, the separation processing means searches the temporary storage device to see if the data specified by the read request is stored in the temporary storage device. If the data specified by the read request is stored in the temporary storage device, the separation processing means returns the data, which was searched for, to the host. If the data specified by the read request is not stored in the temporary storage device, the separation processing means transfers the read request to the storage and, upon receiving data and a response from the storage, returns the data, which was read, and the response to the host

A method in one aspect of the present invention is a separation control method for use between a replication source storage and a replication destination storage, comprising the steps of:

providing a concealment apparatus, which conceals a separation, between a replication source storage and a replication destination storage;

replacing a separation between the replication source storage and the replication destination storage by a separation between the concealment apparatus and the replication destination storage; and

concealing the separation between the replication source storage and the replication destination storage from the replication source storage. In the method according to the present invention, update information transferred from the replication source storage to the replication destination storage during the separation is stored in the temporary storage device.

A method in another aspect of the present invention is a separation control method for use in an information processing system that performs mirroring in which the same data from a host is written in a plurality of storages, comprising the steps of:

providing a plurality of concealment apparatuses, which conceal a separation, between the host and the plurality of storages, one for each storage;

replacing a separation between the host and the storage by a separation between the concealment apparatus and the storage; and concealing the separation between the host and the storage from the host. In the present invention, when a write request to the storage and data are received from the host during the separation, the concealment apparatus stores the write request and the data in a temporary storage device.

A computer program in accordance with one aspect of the present invention causes a computer, which constitutes a concealment apparatus provided between a replication source storage and a replication destination storage to conceal a separation, to store update information, transferred from the replication source storage to the replication destination storage during the separation, in a temporary storage device and thereby to conceal the separation between the replication source storage and the replication destination storage from the replication source storage.

A program in another aspect of the present invention causes a computer of each of a plurality of concealment apparatuses, provided between a host and a plurality of storages to conceal a separation in an information processing system that performs mirroring in which the same data from the host is written in the plurality of storages, to store a write request and data, received from the host, into a temporary storage device during the separation to conceal the separation between the host and the storage from the host.

The meritorious effects of the present invention are summarized as follows.

According to the present invention, a replication source storage system and a replication destination storage system can be separated with no need for the replication source storage system to be concerned in the separation.

According to the present invention, a separation can be implemented by separating between the concealment apparatus and the replication destination storage system during the separation even if the replication source storage system has no separation function.

According to the present invention, resynchronization can be established with the replication destination storage with no need for the replication source storage to be involved in the resynchronization processing.

According to the present invention, a resynchronization can be performed after separation even in storage with no resynchronization function.

According to the present invention, it is determined that the resynchronization is completed (the transition to the normal state is supposed to occur) when there is left no update information stored in the temporary storage in the concealment apparatus and, therefore, the replication source storage system does not have to perform any operation after the resynchronization. According to the present invention, the resynchronization can be implemented with no increase in the load of the replication source storage system. Because the resynchronization does no add any load to the replication source storage system, this configuration allows data to be transferred quickly to the replication destination storage system for resynchronization, thus reducing the time during which the replication destination storage system and the replication source storage system are left unsynchronized.

In the present invention, it is also possible that, upon sensing that a transfer error occurs in the replication destination storage system, the separation concealment apparatus automatically moves to the separation-time operation. This configuration enables even storage with no forced separation function to be compatible with a forced separation.

In the present invention, it is also possible that only the latest update information on the update of the same data block, which is included in the update information stored in the temporary storage device of the concealment apparatus, is held but older update information is discarded. This configuration can reduce the storage capacity required for the temporary storage device.

In the present invention, the updates of the continuous data blocks, included in the update information stored in the temporary storage, can be merged into one piece of information for transfer to reduce the amount of transfer data.

The present invention gives the same effect as that produced in a replication system if applied to a mirroring system in which data is transferred to multiple storages.

Still other features and advantages of the present invention will become readily apparent to those skilled in this art from the following detailed description in conjunction with the accompanying drawings wherein only the preferred embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1A is a diagram showing the basic configuration of the present invention and FIG. 1B is a diagram showing the state transition of the present invention.

FIGS. 2A-2C are flowcharts showing the state transition of the present invention.

FIG. 3 is a diagram showing the configuration of a concealment apparatus in one embodiment of the present invention.

FIG. 4 is a flowchart showing the read operation in one embodiment of the present invention.

FIG. 5 is a flowchart showing ‘write’ (asynchronous replication) in one embodiment of the present invention.

FIG. 6 is a flowchart showing transfer processing performed during asynchronous replication in one embodiment of the present invention.

FIG. 7 is a flowchart showing ‘write’ (synchronous replication) in one embodiment of the present invention.

FIG. 8 is a flowchart showing the operation when the transition to separation occurs in one embodiment of the present invention.

FIG. 9 is a flowchart showing the operation in the separation state in one embodiment of the present invention.

FIG. 10 is a flowchart showing the operation performed when the transition from the resynchronization state to the normal state occurs in one embodiment of the present invention.

FIG. 11 is a flowchart showing the operation of resynchronization processing means in one embodiment of the present invention.

FIG. 12 is a flowchart showing the operation of the receiving side during resynchronization in one embodiment of the present invention.

FIG. 13 is a flowchart showing the configuration of a second embodiment of the present invention.

FIGS. 14A-14C are flowcharts showing the state transition in the second embodiment of the present invention.

FIG. 15 is a diagram showing the configuration of a concealment apparatus in the second embodiment of the present invention.

FIG. 16 is a flowchart showing the read operation in the second embodiment of the present invention.

FIG. 17 is a flowchart showing the read operation in the second embodiment of the present invention.

FIG. 18 is a flowchart showing the read operation in the second embodiment of the present invention.

FIG. 19 is a flowchart showing the write operation in the second embodiment of the present invention.

FIG. 20 is a flowchart showing the operation performed when the transition to separation occurs in the second embodiment of the present invention.

FIG. 21 is a flowchart showing the write operation performed by the concealment apparatus in the separation state in the second embodiment of the present invention.

FIG. 22 is a flowchart showing the read operation of the concealment apparatus in the separation state in the second embodiment of the present invention.

FIG. 23 is a flowchart showing the read operation of the concealment apparatus in the separation state in the second embodiment of the present invention.

FIG. 24 is a flowchart showing the read operation in the separation/resynchronization state in the second embodiment of the present invention.

FIG. 25 is a flowchart showing the read operation in the separation/resynchronization state in the second embodiment of the present invention.

FIG. 26 is a flowchart showing the read operation in the separation/resynchronization state in the second embodiment of the present invention.

FIG. 27 is a flowchart showing the operation performed when the transition from the resynchronization state to the normal state occurs in the second embodiment of the present invention.

FIG. 28 is a flowchart showing the operation of the resynchronization means in the second embodiment of the present invention.

FIG. 29 is a flowchart showing the write operation in the resynchronization state in the second embodiment of the present invention.

FIG. 30 is a flowchart showing the read operation performed by the concealment apparatus in the resynchronization state in the second embodiment of the present invention.

FIG. 31 is a flowchart showing the read operation performed by the concealment apparatus in the resynchronization state in the second embodiment of the present invention.

FIG. 32 is a flowchart showing the read operation performed by the concealment apparatus in the resynchronization state in the second embodiment of the present invention.

FIG. 33 is a diagram showing the configuration of the concealment apparatus in the second embodiment of the present invention.

### PREFERRED EMBODIMENTS OF THE INVENTION

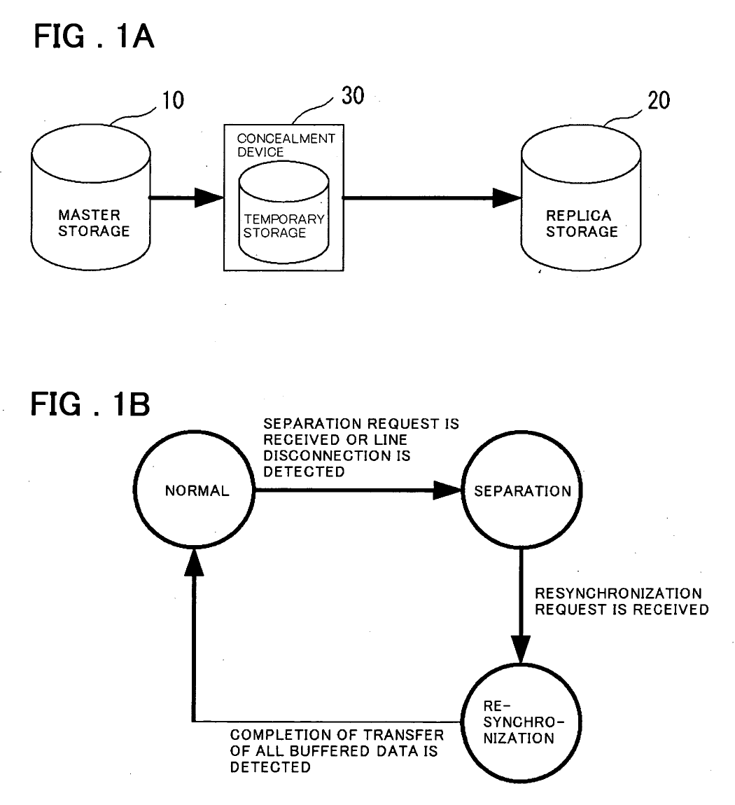

The present invention will be described below more in detail with reference to the attached drawings. FIG. 1A is a diagram showing the basic configuration of the present invention. FIG. 1B is a diagram showing an example of state transition of the present invention. Referring to FIG. 1A, a system in one embodiment of the present invention, there is arranged a concealment apparatus (separation concealment apparatus) 30 which has a temporary storage, between master storage 10 and replica storage 20. The concealment apparatus 30 is provided to replace the separation (disconnection) between the master storage 10 and the replica storage 20 with the separation between the concealment apparatus 30 and the replica storage 20 to conceal the separation, which occurs between the master storage 10 and the replica storage 20, from the master storage 10.

Referring to FIG. 1B, when a separation request is entered or a line (network) error is detected during normal replication, a transition to separation occurs. During the separation, the concealment apparatus 30 receives update information, transferred from the master storage 10 to the replica storage 20, and stores the received update information in the temporary storage (buffer).

The concealment apparatus 30 performs resynchronization processing when a resynchronization request is received during the separation. During the resynchronization, the update information stored in the temporary storage of the concealment apparatus 30 is transferred to the replica storage 20 and, upon detecting that the transfer of the update information stored in the temporary storage is completed, a transition to the normal state occurs. During the resynchronization, the concealment apparatus 30 can conceal the resynchronization processing from the master storage 10.

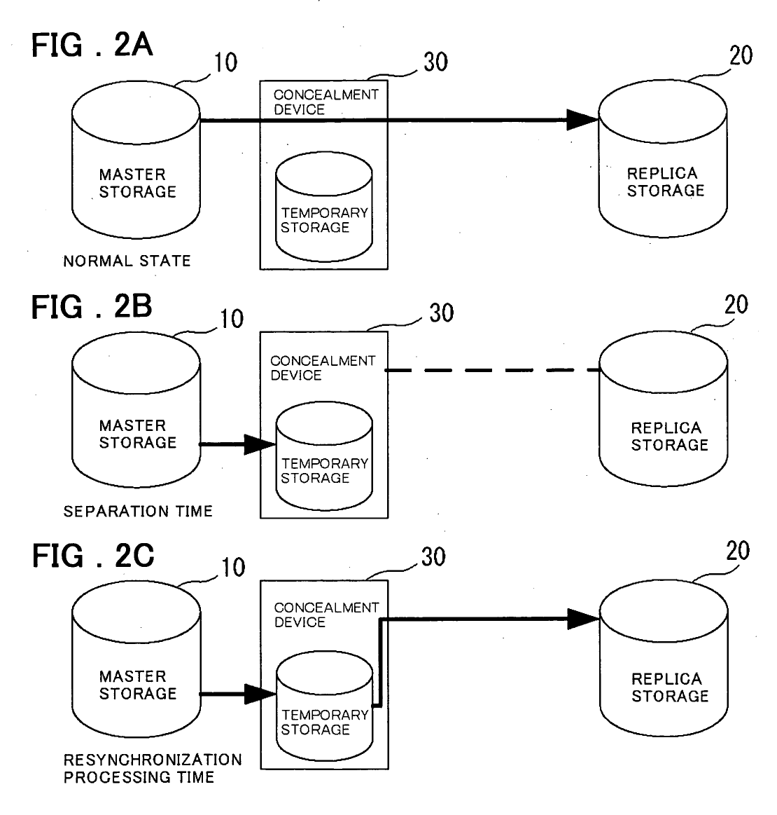

FIG. 2A, FIG. 2B, and FIG. 2C are diagrams schematically showing the configuration of processing at the normal state (normal replication) time, separation time, and resynchronization time, respectively.

The concealment apparatus 30 stores update information, transferred from the master storage 10, in the temporary storage during separation and during the time synchronization is being established between unsynchronized master storage 10 and replica storage 20. When connected to the replica storage 20, the concealment apparatus 30 transfers the update information, stored in the temporary storage of the concealment apparatus 30, to cause the replica storage 20 to get synchronized with the master storage 10.

The amount A stored in the temporary storage from time 0 to time k is a value generated by integrating St from time 0 to time k, where St is the update amount (update information data amount, write data amount+additional information amount) at time t. Let S be the average update amount per unit time. Then, the amount A stored in the temporary storage from time 0 to time k is approximated as follows.
A=S×k

First, with reference to FIG. 2A, the following describes the normal state (normal replication). The concealment apparatus 30 transfers update information, sent from the master storage 10, to the replica storage 20. In the normal state, the concealment apparatus 30 transfers update information, sent from the master storage 10, to the replica storage 20 in the through mode.

Alternatively, the concealment apparatus 30 may once store update information, sent from the master storage 10, in the temporary storage and then transfers it to the replica storage 20. In this case, the concealment apparatus 30 may return a response to the master storage 10 when the update information, sent from the master storage 10, is stored in the temporary storage. If the transfer from the master storage 10 is carried out in a manner of a synchronous replication, the replication is changed to the asynchronous replication.

When the update information is received from the concealment apparatus 30, the replica storage 20 copies the update information and returns a response to the master storage 10.

The response sent from the replica storage 20 to the concealment apparatus 30 is transferred to the master storage 10.

Next, the following describes the processing performed at separation time shown in FIG. 2B. The concealment apparatus 30 stores update information, sent from the master storage 10, in the temporary storage in the device.

The concealment apparatus 30 stores the update information, sent from the master storage 10, in the temporary storage. The update information sent from the master storage 10 is held in the concealment apparatus 30 but is not transferred to the replica storage 20. The concealment apparatus. 30 returns a response to the master storage 10 when it receives the update information from the master storage 10 and stores the received update information in the temporary storage. This configuration conceals the effect, caused by storing the update information in the temporary storage, when the update information is transferred from the master storage 10 in the synchronous replication mode.

Next, the following describes resynchronization processing shown in FIG. 2C. During the resynchronization processing, the concealment apparatus 30 transfers the update information, stored in the temporary storage of the concealment apparatus 30, to the replica storage 20 and, when there is left no update information stored in the temporary storage in the concealment apparatus 30, the master storage 10 and the replica storage 20 get synchronized and the transition to the normal operation occurs.

During the resynchronization processing, the concealment apparatus 30 stores the update information, sent from the master storage 10, in the temporary storage, until all the update information stored in the temporary storage in the concealment apparatus 30 are gone. At this time, the concealment apparatus 30 returns a response to the master storage 10 when the update information, sent from the master storage 10, is stored in the temporary storage. The concealment apparatus 30 retrieves the update information, stored in the temporary storage in the concealment apparatus 30, and transfers the retrieved update information to the replica storage 20. The arrival order (old, new) of the update information may also be related to the update information and written in the temporary storage to manage the arrival order of the update information.

According to the present invention, the master storage 10 and the replica storage 20 can be separated with no need for the master storage 10 to be concerned with the separation.

According to the present invention, the separation processing can be implemented even on storage with no separation function because the concealment apparatus and the replica storage are separated during the separation.

According to the present invention, the master storage 10 and the replica storage 20 can be resynchronized with no need for the master storage 10 to be concerned with the resynchronization.

In addition, according to the present invention, the resynchronization processing after the separation can be performed even on storage with no resynchronization function because the concealment apparatus 30 performs the resynchronization processing.

According to the present invention, the resynchronization is completed (the transition to the normal state occurs) when there is left no update information stored in the temporary storage in the concealment apparatus. Therefore, after the master storage and the replica storage get resynchronized, the master storage 10 need not perform any additional processing (processing for establishing resynchronization with the replica storage).

That is, the present invention can establish resynchronization without increasing the load of the master storage. Thus, the resynchronization processing does not add any additional processing load to the master storage. The resynchronization that does not add any load to the master storage 10 allows the master storage to quickly transfer the update information for establishing resynchronization with the replica storage. This method also reduces the time during which the replica storage and the master storage are left unsynchronized, thus decreasing the effect of a disaster.

In the present invention, it is also possible that, when an error is detected during the update information transfer to the replica storage, the separation concealment apparatus automatically starts the separation-time operation. This configuration enables storage with no forced-separation function to perform forced separation.

In the present invention, it is also possible that, for the update information of the same data block stored in the temporary storage, only the latest update information is stored but the older update information is discarded. This configuration reduces the storage amount of the temporary storage.

In the present invention, it is also possible that the consecutive data blocks of the update information stored in the temporary storage are merged into one piece of information for transfer to the replica storage. For example, the two write requests and the data are merged into one for transfer to the replica storage to reduce the amount of data transfer. The following describes the present invention using embodiments.

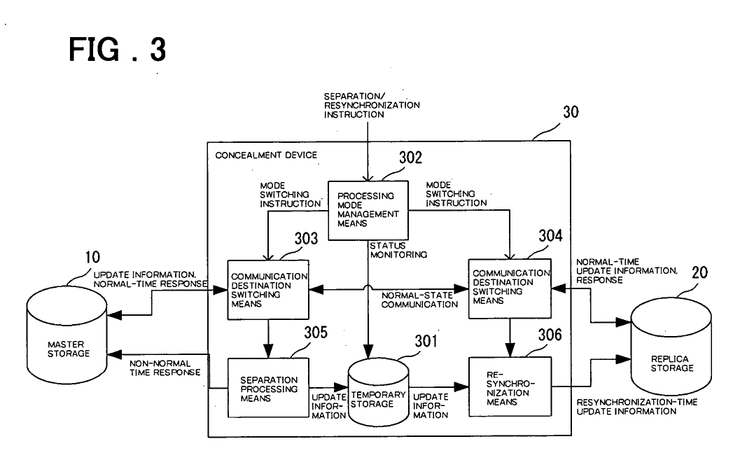

FIG. 3 is a diagram showing the configuration of a concealment apparatus in one embodiment of the present invention. The concealment apparatus 30 provided between the master storage 10 and the replica storage 20 comprises temporary storage 301, processing mode management means 302, first and second communication destination switching means 303 and 304, separation processing means 305, and resynchronization means 306.

In response to a separation (disconnection) instruction or a resynchronization instruction, the processing mode management means 302 controls mode switching and, at the same time, monitors the status of the temporary storage 301. The concealment apparatus may also be configured in such a way that, in response to a monitor result signal (used as a control signal) from a monitor device (not shown) that monitors the line (network) connecting the concealment apparatus 30 and the replica storage 20, a separation (disconnection) instruction is issued when a line (network) error is detected during normal replication processing or a resynchronization processing instruction is issued when a line (network) error is recovered. Alternatively, the concealment apparatus may be configured in such a way that a separation instruction or a resynchronization instruction is entered from, and controlled by, the management terminal of a system manager.

In the present embodiment, the master storage 10 is not concerned with any of transitions that occur from the normal state to the separation state or from the separation state to the resynchronization state. This is one of the characteristics of the present invention. In both the separation state and the resynchronization state, the master storage 10 performs normal operation processing and copies update information to the replica storage 20.

The first communication destination switching means 303 receives update information from the master storage 10 and returns a normal-time response.

The second communication destination switching means 304 communicates with the first communication destination switching means 303 in the normal state (normal replication), transfers update information from the master storage 10 to the replica storage 20, and receives a normal-time response (response to master storage 10) from the replica storage 20.

The separation processing means 305 stores update information, sent from the master storage 10, into the temporary storage 301 during separation time under control of the processing mode management means 302 and, when the update information is stored in the temporary storage 301, returns a response to the master storage 10.

The resynchronization means 306 reads update information from the temporary storage 301 during resynchronization time under control of the processing mode management means 302 and transfers the update information to the replica storage 20.

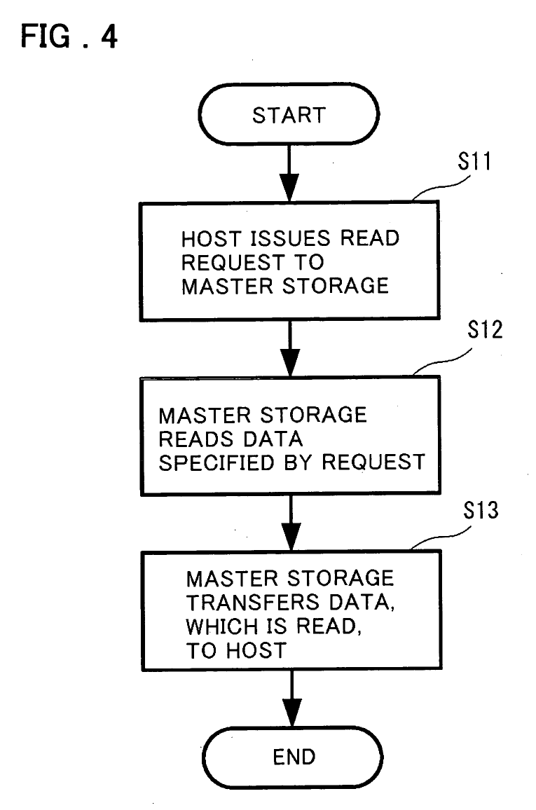

FIG. 4 is a flowchart showing the normal-time read operation in one embodiment of the present invention described with reference to FIG. 1 to FIG. 3. Referring to FIG. 4, the following describes the read operation in the present embodiment.

The host (not shown) issues a read request to the master storage 10 (step S11).

The master storage 10 reads data specified by the read request (step S12).

The master storage 10 transfers data, which is read, to the host (not shown) (step S13). The read operation described above is executed not only in the normal state but also during separation time and resynchronization time.

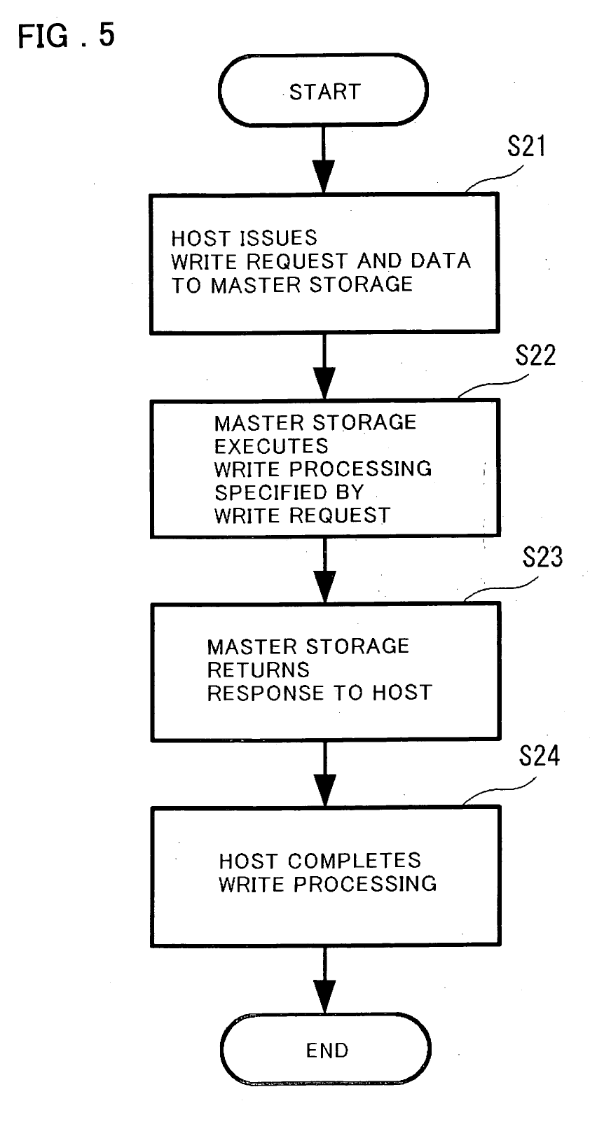

FIG. 5 is a flowchart showing the asynchronous replication operation in one embodiment of the present invention. Referring to FIG. 5, the following describes the asynchronous replication operation in the present embodiment.

The host (not shown) issues a write request and data (write data) to the master storage 10 (step S21).

The master storage 10 executes the write processing specified by the write request (step S22).

When the write processing is completed, the master storage 10 returns a response to the write request to the host (not shown) (step S23).

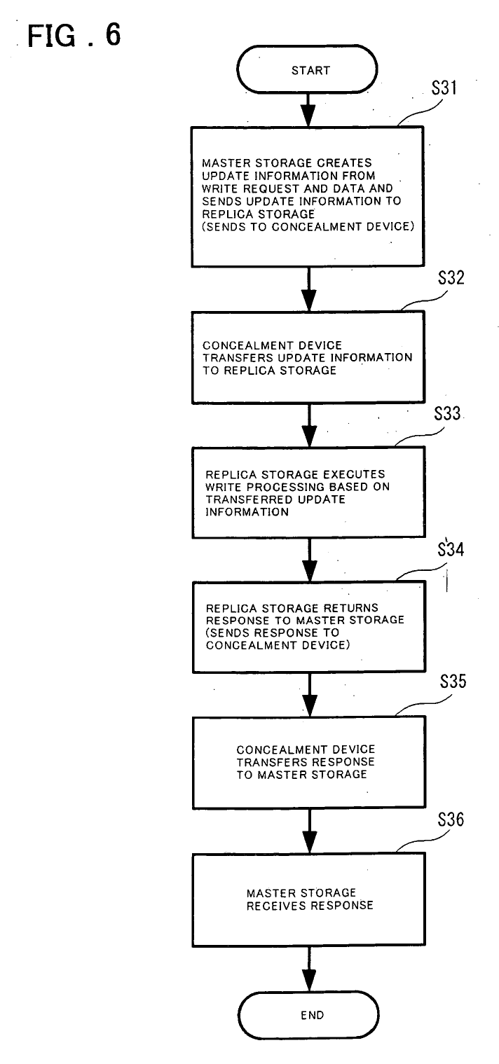

The host (not shown) completes the write processing (step S24). The replication from the master storage 10 to the replica storage 20 is performed asynchronously after the write processing in the master storage 10 is completed (See FIG. 6 for the replication processing). The write operation described above is executed not only in the normal state but also during separation time or resynchronization time.

FIG. 6 is a flowchart showing transfer processing performed during asynchronous replication in the present embodiment. This transfer processing is executed asynchronously after the write processing in FIG. 5. Referring to FIG. 6, the following describes the transfer processing performed during asynchronous replication.

The master storage 10 creates update information from the write request and data (transferred from the host) and sends the update information to the replica storage 20 (step S31). In the present embodiment, the concealment apparatus 30 receives the update information.

The concealment apparatus 30 receives the update information from the master storage 10 and transfers the received update information to the replica storage 20 (step S32).

The replica storage 20 executes write processing based on the transferred update information (step S33).

The replica storage 20 returns a response to the transfer processing to the master storage 10 (step S34). In the present embodiment, the concealment apparatus 30 receives the response from the replica storage 20.

The concealment apparatus 30 transfers the response, received from the replica storage 20, to the master storage 10 (step S35).

The master storage 10 receives the response from the concealment apparatus 30 (step S36).

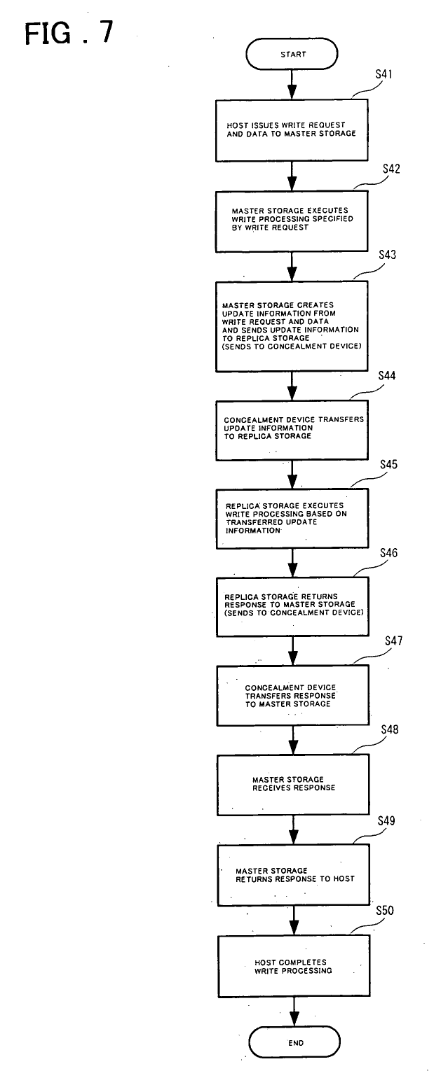

FIG. 7 is a flowchart showing the write processing (synchronous replication) in the present embodiment. Referring to FIG. 7, the following describes the synchronous replication operation.

The host (not shown) issues a write request and data to the master storage 10 (step S41).

The master storage 10 receives the write request and the data from the host and executes the write processing specified by the write request (step S42).

The master storage 10 creates update information from the write request and the data, received from the host, and sends the update information to the replica storage 20 (step S43). The concealment apparatus 30 receives the update information.

The concealment apparatus 30 transfers the update information, received from the master storage 10, to the replica storage 20 (step S44).

The replica storage 20 executes the write processing based on the update information transferred from the concealment apparatus 30 (step S45).

The replica storage 20 returns a response to the master storage 10 (step S46). The concealment apparatus 30 receives the response from the replica storage 20.

The concealment apparatus 30 transfers the response, received from the replica storage 20, to the master storage (step S47).

The master storage 10 receives the response from the concealment apparatus 30 (step S48).

The master storage 10 returns the response to the host (not shown) (step S49).

The host (not shown) completes the write processing (step S50).

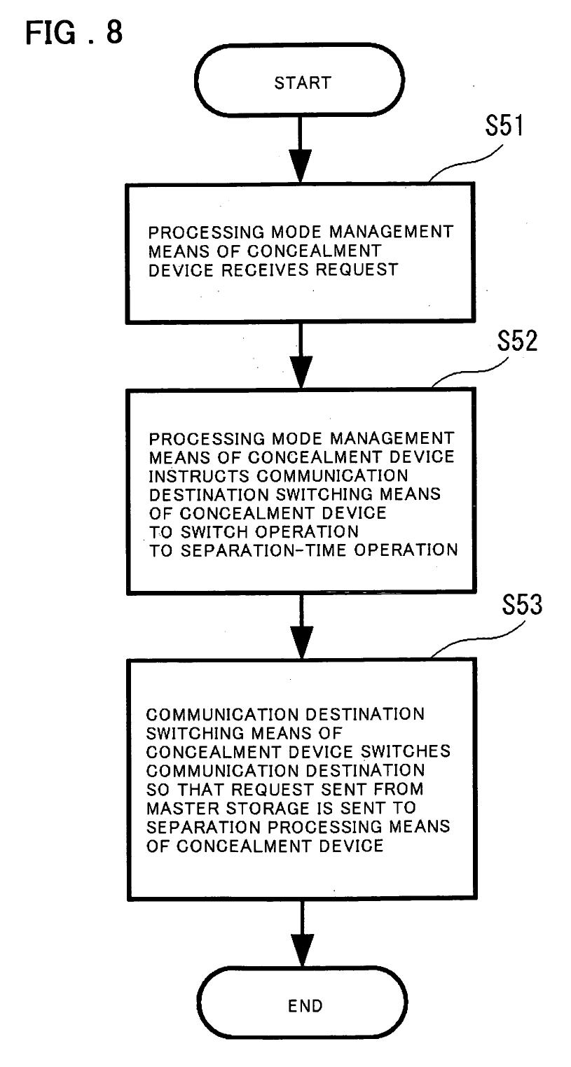

FIG. 8 is a flowchart showing the operation (replication) when the transition to separation occurs in the normal state in the present embodiment. Referring to FIG. 8, the following describes the operation when the transition to separation occurs.

The processing mode management means 302 of the concealment apparatus 30 receives a separation request from a management terminal (not shown) or a network monitor device (not shown) (step S51).

The processing mode management means 302 of the concealment apparatus 30 instructs the first communication destination switching means 303 of the concealment apparatus 30 to switch the operation to the separation-time operation (step S52).

The communication destination switching means 303 of the concealment apparatus 30 switches the communication destination so that a request sent from the master storage 10 is sent to the separation processing means 305 of the concealment apparatus 30 (step S53).

In the present embodiment, if copy data is transferred from the master storage 10 during the transition-to-separation processing described above, the master storage 10 does not receive a response from the replica storage 20 and, so, the master storage 10 retries to transfer the update information. However, there is no inconvenience because, after the transition to the separation state occurs, the separation processing means 305 of the concealment apparatus 30 performs its processing (that is, stores the update information, transferred from the master storage 10, in the temporary storage 301).

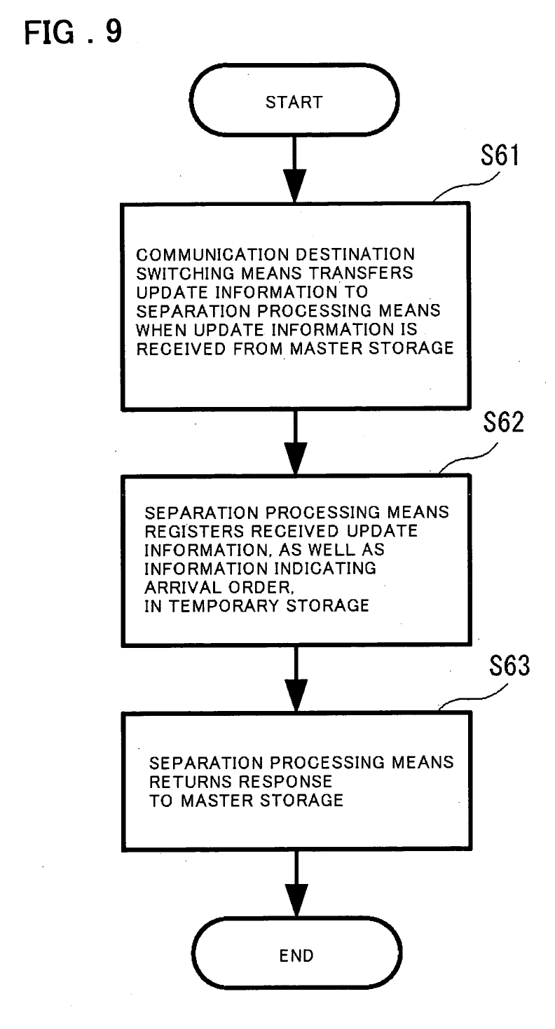

FIG. 9 is a flowchart showing the operation performed in the separation state in the present embodiment. Referring to FIG. 9, the following describes the operation performed in the separation state.

When the concealment apparatus 30 receives update information from the master storage 10, the first communication destination switching means 303 transfers the update information to the separation processing means 305 (step S61).

The separation processing means 305 registers information indicating the arrival order, as well as the received update information, in the temporary storage 301 (step S62). The temporary storage 301 (buffer) may be an HDD or a semiconductor memory. The temporary storage 301 may also be configured as a buffer into or from which data is written or read on a FIFO (First-In, First-Out) basis. In addition, the arrival order information or the timestamp information may also be stored to manage which update information (same block data) is least recent or most recent.

After the separation processing means 305 stores the update information in the temporary storage 301, it returns a response to the master storage 10 (step S63).

In the present embodiment, if the update information is already transferred from the master storage 10 to the replica storage 20 when a separation request is issued, the response is transferred from the replica storage 20 to the concealment apparatus 30. In this case, the following action is taken in the present embodiment as needed.

If the concealment apparatus 30 receives the response after the first communication destination switching means 303 is switched to the separation state, the separation processing means 305, which sends a non-normal-time response to the master storage 10, may send an un-transfer (error) response to the master storage 10. This response corresponds to an error response that the separation processing means 305 sends to the master storage 10 when the resynchronization means 306 fails in transferring the update information, stored in the temporary storage 301, to the replica storage 20 during resynchronization time. If the concealment apparatus 30 receives the response before the first communication destination switching means 303 is switched to the separation state, the response received by the second communication destination switching means 304 is sent directly from the first communication destination switching means 303 to the master storage 10 as in the normal state.

If a forced separation occurs due to an error, the master storage 10 retries to send the update information (The master storage 10 retries to send the update information several times because the response is not returned from the replica storage to the master storage 10). Therefore, no incompatibility problem is generated. If a separation occurs during the retry, the update information to be transferred by the retry is stored in the temporary storage of the concealment apparatus 30.

It is also possible to configure the concealment apparatus in such a way that, for the update information stored in the temporary storage 301 and applied to the same data block for updating in the separation state, the update information other than the latest is discarded. This configuration can reduce the required storage amount of the temporary storage 301. This configuration also reduces the amount of transferred update information during resynchronization time, thus reducing the resynchronization processing time.

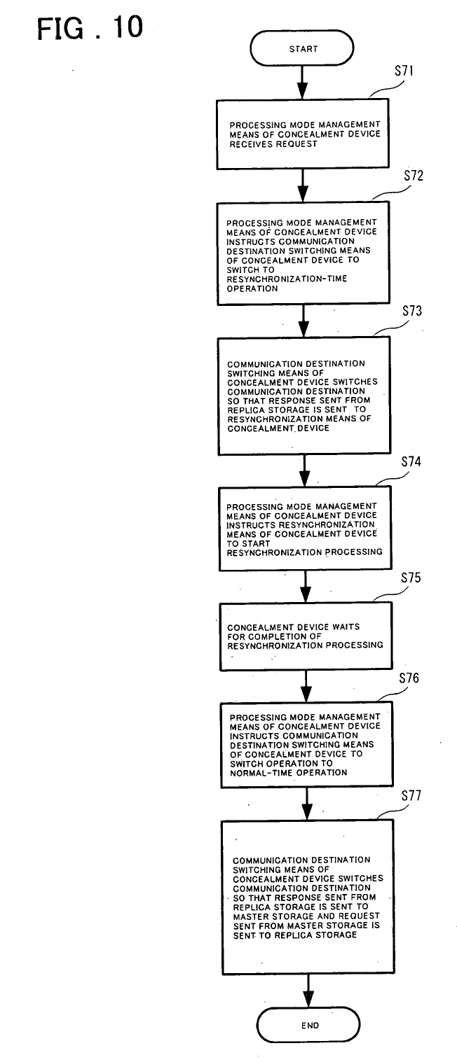

FIG. 10 is a flowchart showing the operation that is performed when the transition from the resynchronization state to the normal state (normal replication) occurs in one embodiment of the present invention. Referring to FIG. 10, the following describes the restoration from the resynchronization state to the normal state.

The processing mode management means 302 of the concealment apparatus 30 receives a resynchronization request (step S71). As described above, the resynchronization request may be automatically generated by the network monitor (not shown) that detects a network recovery or by the system manager on the management terminal (not shown) connected to the concealment apparatus 30.

The processing mode management means 302 of the concealment apparatus 30 instructs the second communication destination switching means 304 to switch the operation to the resynchronization-time operation (step S72).

The second communication destination switching means 304 of the concealment apparatus 30 switches the communication destination so that a response sent from the replica storage 20 is sent to the resynchronization means 306 of the concealment apparatus 30 (step S73).

The processing mode management means 302 of the concealment apparatus 30 instructs the resynchronization means 306 of the concealment apparatus to start resynchronization processing (step S74).

The concealment apparatus waits for the completion of the resynchronization processing (step S75). During this time, the processing mode management means 302 of the concealment apparatus 30 monitors the storage amount of the temporary storage 301 and, when there is left no the update information stored in the temporary storage 301, decides that the resynchronization is completed.

When the resynchronization is completed, the processing mode management means 302 of the concealment apparatus 30 instructs the first and second communication destination switching means 303 and 304 of the concealment apparatus to switch the operation to the normal operation (step S76).

The second communication destination switching means 304 of the concealment apparatus 30 switches the communication destination so that the response sent from the replica storage 20 is sent to the master storage 10 via the first communication destination switching means 303. The first communication destination switching means 303 switches the communication destination so that the request sent from the master storage 10 is sent to the replica storage 20 via the second communication destination switching means 304 (step S77). This configuration allows the concealment apparatus 30 to automatically switch the operation from the separation state to the resynchronization and then to the normal state.

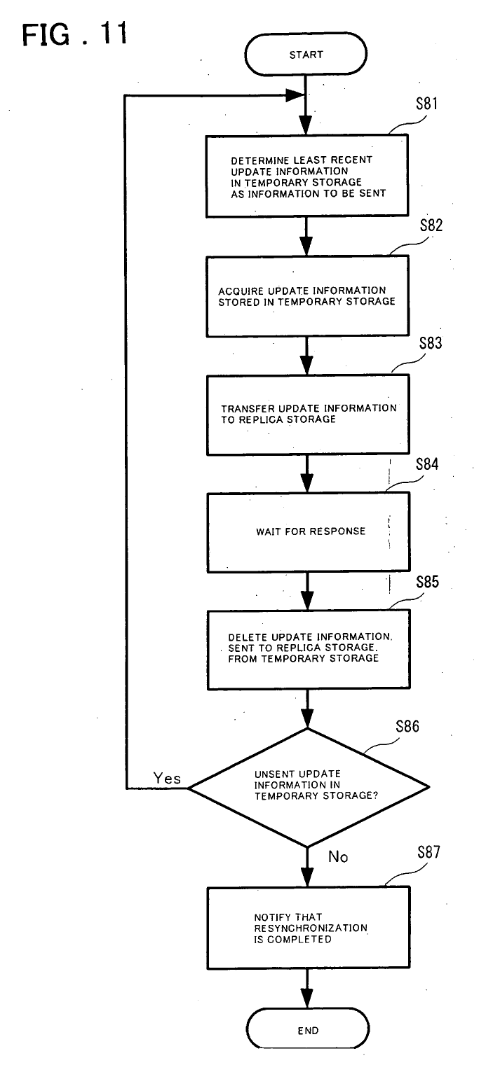

FIG. 11 is a flowchart showing the processing operation of the resynchronization means 306 of the concealment apparatus 30 in one embodiment of the present invention. Referring to FIG. 11, the following describes the operation of the resynchronization means 306 during resynchronization time.

At resynchronization time, the resynchronization means 306 determines the least recent update information in the temporary storage 301 as the information to be sent (step S81).

The resynchronization means 306 acquires the update information stored in the temporary storage 301 (step S82).

The resynchronization means 306 transfers the update information to the replica storage 20 (step S83).

The resynchronization means 306 waits for the replica storage 20 to return a response (step S84).

The resynchronization means 306 deletes the update information, sent to the replica storage 20, from the temporary storage 301 (step S85). It is also possible to delete the update information by releasing the buffer area in which the update information is stored at the time the update information is read from the temporary storage 301. As a modification, it is also possible to turn on the deletion flag (for example, a bit flag in a predetermined storage area in the temporary storage 301) corresponding to update information that is sent from the temporary storage 301 to the replica storage 20.

If there is still unsent information in the temporary storage 301 (Yes in step S86), control is passed back to step S81.

If there is no unsent information in the temporary storage 301 (No in step S86), the processing mode management means 302 notifies the first and second communication destination switching means 303 and 304 and the resynchronization means 306 that the resynchronization is completed.

In the present embodiment, it is also possible that the first and second communication destination switching means 303 and 304 request the master storage 10 to delay an update information transfer request until the resynchronization is completed. This configuration avoids the condition in which the update information stays long in the temporary storage 301. That is, though the update information from the master storage 10 is stored in the temporary storage 301 before resynchronization is completed, the master storage 10 is forced to delay the subsequent transfer requests until all or most of the update information, stored in the temporary storage 301 up to the moment a transfer request reached the concealment apparatus 30, is transferred to the replica storage 20.

It is also possible to apply update information, transferred from the master storage 10 during resynchronization, directly to the replica storage 20 and thereby skip applying update information transferred from the temporary storage 301 for the blocks to which the update information has already been applied. This configuration reduces the amount of transfer during resynchronization and to reduce the resynchronization processing time.

When the resynchronization means 306 transfers update information, stored in the temporary storage 301, to the replica storage 20 during resynchronization but no response is received from the replica storage 20, the separation processing means 305 may notify an error response about the transfer of the update information to the master storage 10.

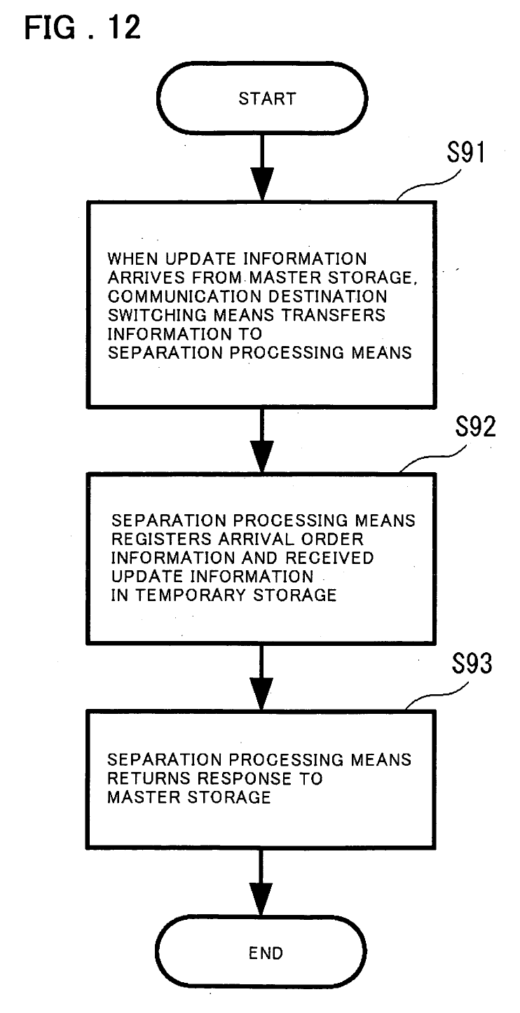

FIG. 12 is a flowchart showing the operation of the receiving side in the resynchronization state in the present embodiment. Referring to FIG. 12, the following describes the reception operation of update information from the master storage 10 in the resynchronization state.

When update information arrives from the master storage 10, the first communication destination switching means 303 transfers the update information to the separation processing means 305 (step S91).

The separation processing means 305 registers the arrival order information and the received update information in the temporary storage 301 (step S92).

The separation processing means 305 returns a response to the master storage 10 (step S93). In this way, update information, received from the master storage 10 during resynchronization, is stored in the temporary storage 301. It is of course possible, as described above, that the storing update information received from the master storage 10 is kept waiting until the temporary storage 301 becomes empty.

Next, another embodiment of the present invention will be described below. A second embodiment of the present invention is configured to conceal separation in a mirroring system, such as RAIDI, that increases the reliability by writing the same data in multiple storages (HDD: hard disk).

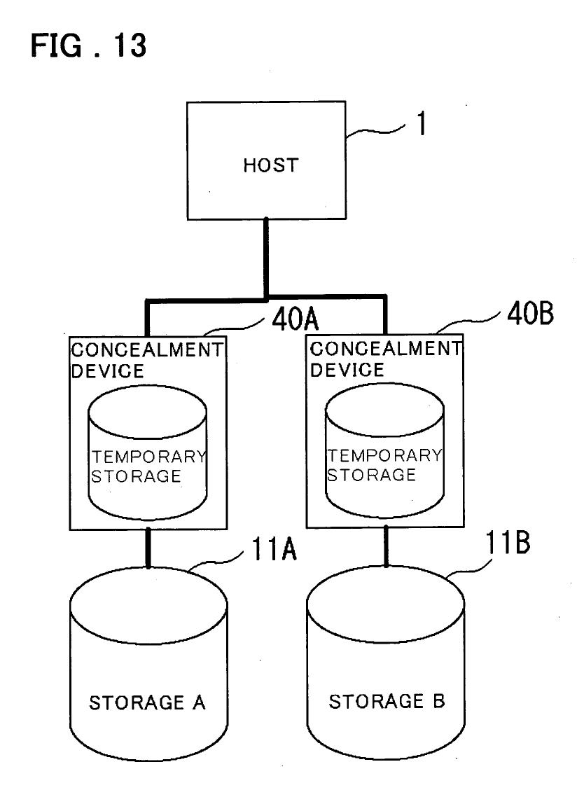

FIG. 13 is a diagram showing the basic configuration of the second embodiment of the present invention. Referring to FIG. 13, concealment apparatuses 40A and 40B are provided between a host 1 and storages 11A and 11B. In the normal state, a request and data are transferred between the host 1 and the storages 11A and 11B in the through mode. The configuration of a general mirroring system is the configuration of the system in FIG. 13 from which the concealment apparatuses 40A and 40B, provided between the host 1 and the storages 11A and 11B, are removed. Although two storages are shown in FIG. 13, the number of storages is not, of course, limited to two in the present invention.

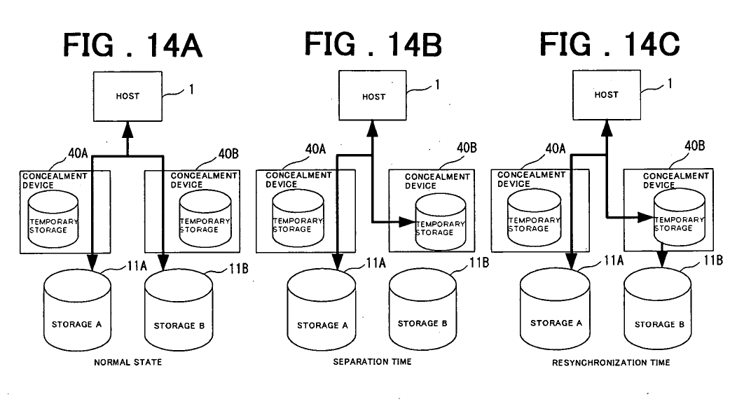

FIGS. 14A-14C are diagrams showing the state transition of the second embodiment of the present invention shown in FIG. 13. In the normal state, update information sent from the host 1 is written to both storages A and B (see FIG. 4A).

When storages A and B are separated, the update information sent from the host 1 is written into the temporary storage 401 of the concealment apparatus 40B (see FIG. 4B).

In the resynchronization state, the data stored in the temporary storage of the concealment apparatus 40B is written to the storage 11B.

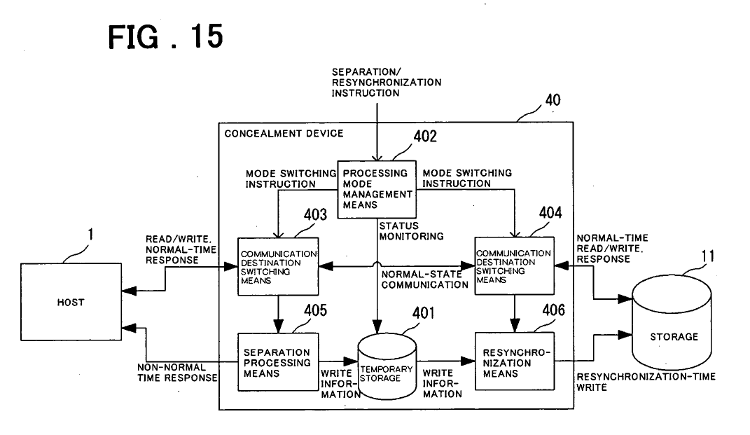

FIG. 15 is a diagram showing the configuration of the concealment apparatus in the second embodiment of the present invention. The basic configuration a concealment apparatus 40 in FIG. 15 is similar to that of the concealment apparatus in the first embodiment except that the master storage 10 in FIG. 3 is replaced with the host 1. In FIG. 15, processing mode management means 402 controls the mode switching in response to a separation (disconnection) instruction or a resynchronization instruction and, at the same time, monitors the status of the temporary storage 401. Instead of this, it is also possible that, in response to a monitor result signal, which is used as the control signal, from a monitor device (not shown) monitoring the line (network) connecting the concealment apparatus 40 and the storage 11, a separation (disconnection) instruction is issued when a line (network) error is detected in the normal replication state (forced separation) and a resynchronization processing instruction is issued when the line (network) error is recovered. Alternatively, a separation instruction or a resynchronization instruction may be specified and controlled by the management terminal of the system manager.

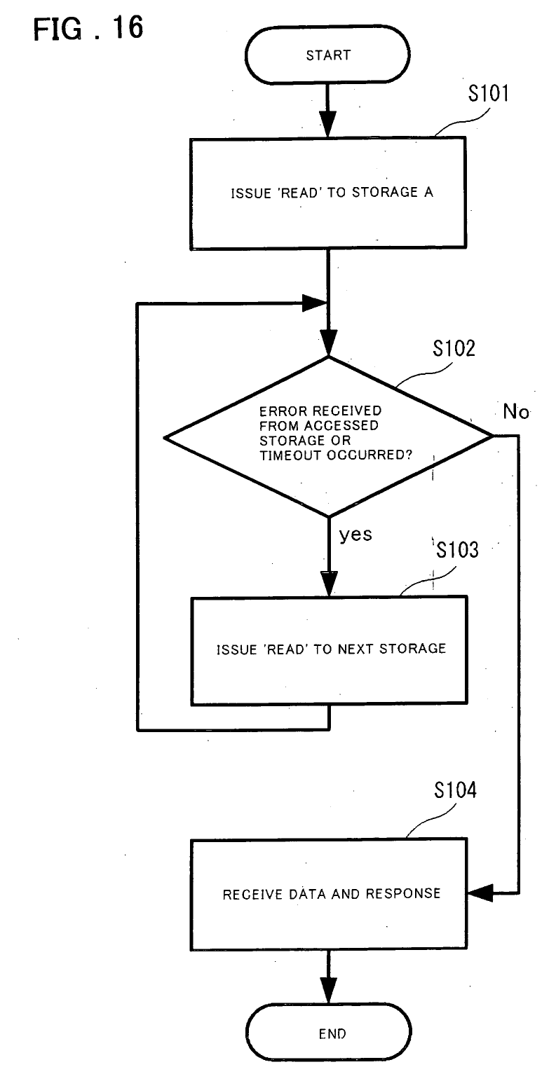

FIG. 16 is a flowchart showing the read processing in the second embodiment (mirroring) of the present invention. With reference to FIG. 16, the following describes the read operation.

The host 1 issues ‘read’ to storage A (step S101).

If data is read normally (No in step S102), the host 1 receives the data and a response (step S104). If an error is received from the accessed storage or a timeout occurs (Yes in step S102), ‘read’ is issued to the next storage (step S103).

The policy for determining to which one of multiple storages the host 1 should issue the first read request is as follows.
Fixed
Determined on a circular basis (A and then B)
Determined based on load balancing (the request is issued to storages so that the load becomes even based on the number of requests being processed).

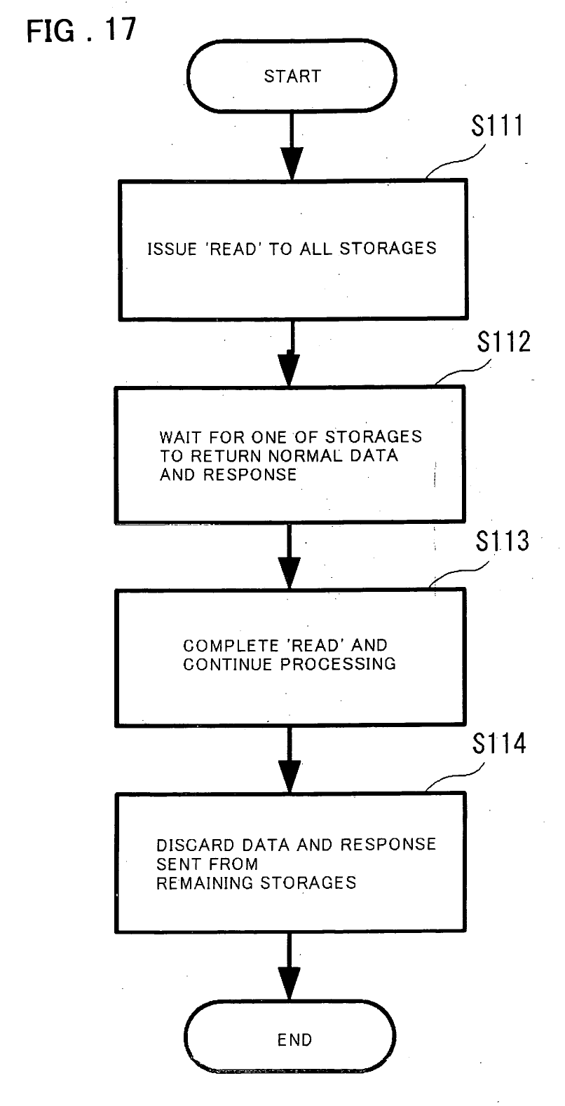

FIG. 17 is a flowchart showing another mode of read processing in the second embodiment (mirroring) of the present invention. The following describes the read operation with reference to FIG. 17.

The host 1 issues ‘read’ to all storages A and B (step S111) (see FIG. 17).

The host 1 waits for one of storages to return normal data and a response (step S112).

When normal data and a response are received from one of storages, the host 1 completes ‘read’ and continues the processing (step S113).

The host 1 discards data and a response sent from the remaining storages (step S114).

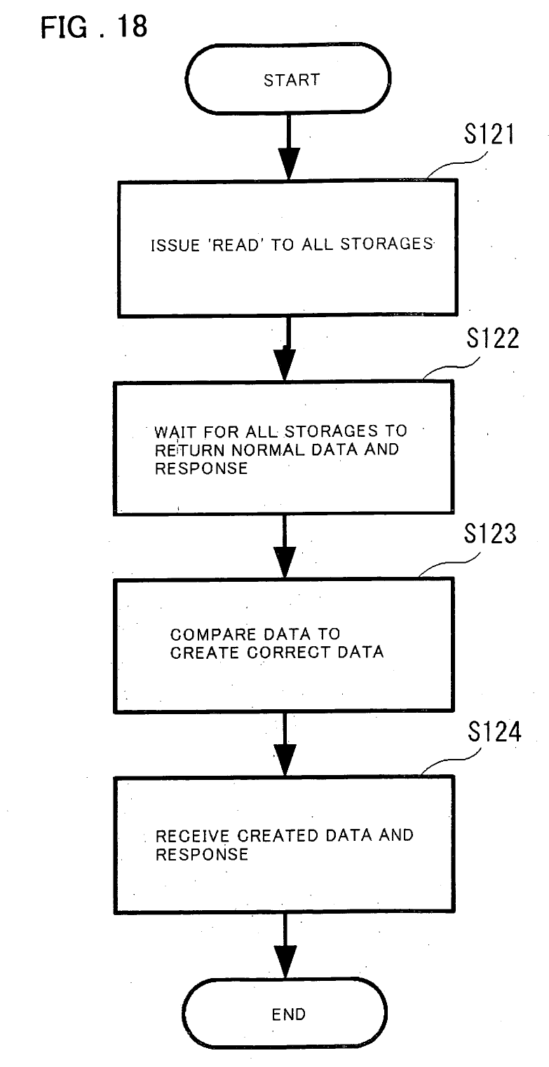

FIG. 18 is a flowchart showing still another mode of read processing in the second embodiment (mirroring) of the present invention.

The host 1 issues ‘read’ to all storages (step S121).

The host 1 waits for all storages to return normal data and a response (step S122).

The host 1 compares data sent from the multiple storages to create correct data (step S123). For example, the host 1 generates correct data from the data, received from the multiple storages, by majority decision.

The host 1 determines the created one pair of data and the response as the data that is read (step S124).

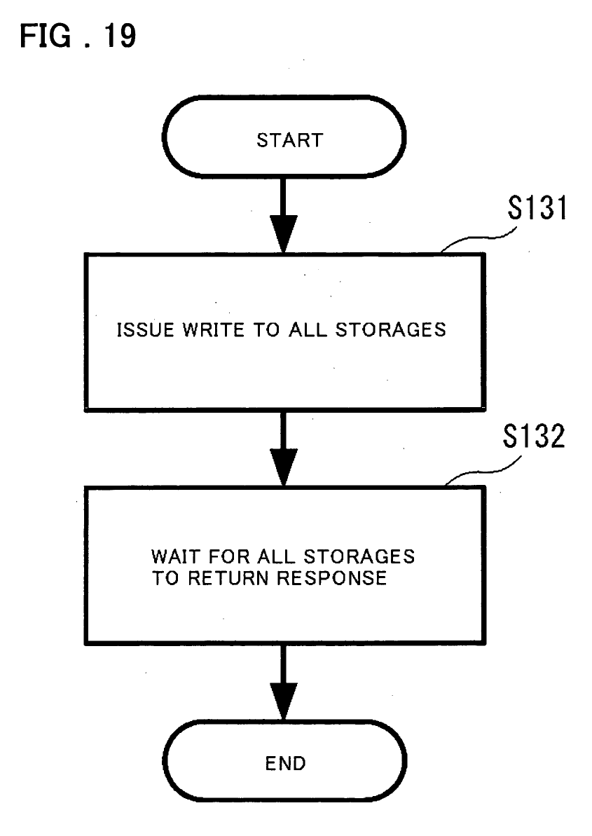

FIG. 19 is a flowchart showing write processing in the second embodiment (mirroring) of the present invention. With reference to FIG. 19, the following describes the write processing.

The host 1 issues ‘write’ to all storages A and B (step S131).

The host 1 waits for all storages to return a response (step S132).

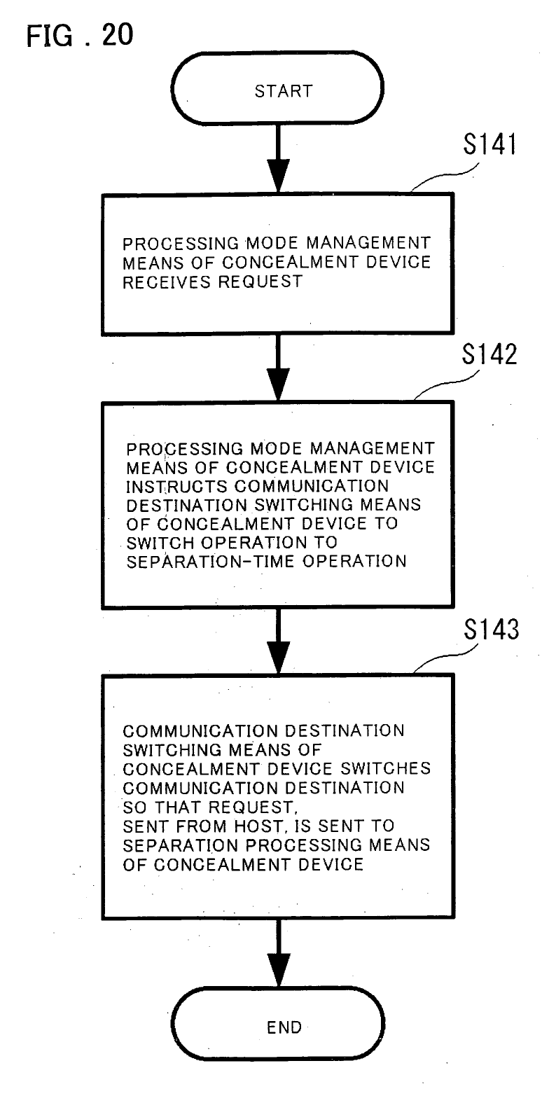

FIG. 20 is a flowchart showing the operation (mirroring) performed when the transition to separation occurs in the second embodiment (mirroring) of the present invention. With reference to FIG. 20, the following describes the operation (mirroring) when the transition to separation occurs.

The processing mode management means 402 of the concealment apparatus 40 receives a separation (disconnection) request (step S141). As described above, it is also possible that the signal from a network monitoring device not shown or a separation (disconnection) instruction from the management terminal of a system manager is supplied to the concealment apparatus 40 as the control signal.

The processing mode management means 402 of the concealment apparatus 40 instructs first communication destination switching means 403 of the concealment apparatus 40 to switch the operation to the separation-time operation (step S142).

The first communication destination switching means 403 of the concealment apparatus 40 switches the communication destination so that the request, sent from the host 1, is sent to separation processing means 405 of the concealment apparatus 40 (step S143).

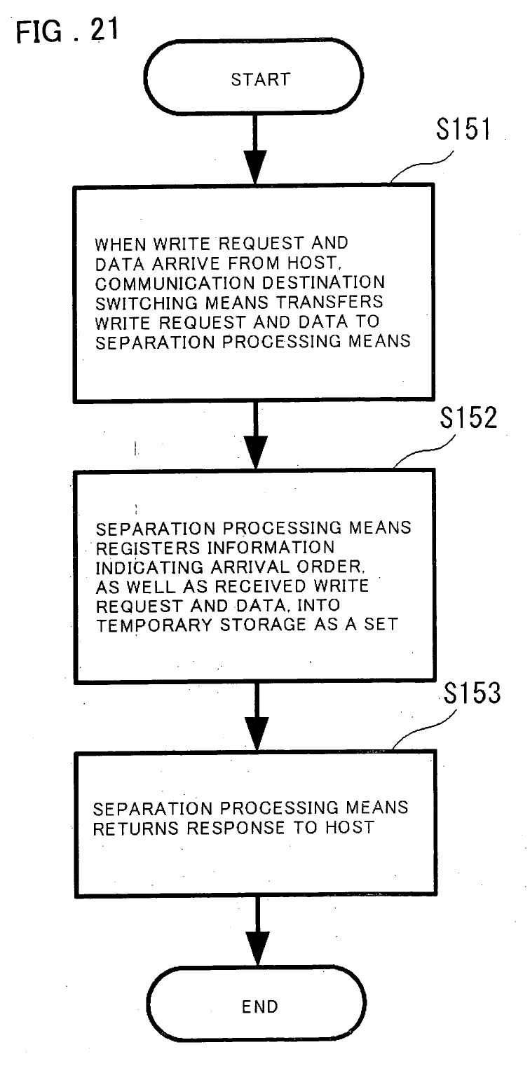

FIG. 21 is a flowchart showing the operation performed in the separation state in the second embodiment (mirroring) of the present invention. FIG. 21 shows the processing performed after the processing in FIG. 20. With reference to FIG. 21, the following describes the operation in the separation state.

When a write request and data issued from the host 1 arrives the concealment apparatus 40, the first communication destination switching means 403 of the concealment apparatus 40 transfers the write request and the data to the separation processing means 405 (step S151).

The separation processing means 405 registers information indicating the arrival order, as well as the received write request and data, into temporary storage 401 as a set (step S152).

The separation processing means 405 returns a response to the host 1 (step S153).

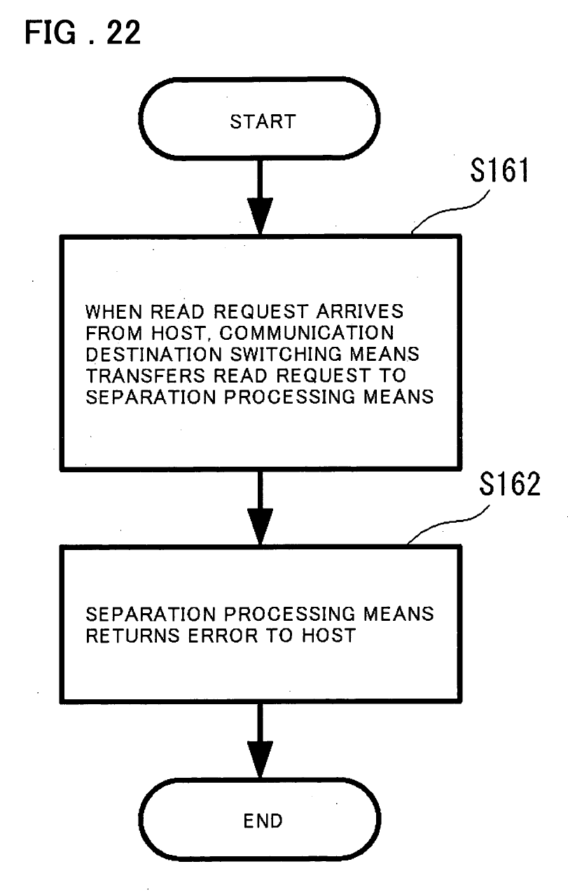

FIG. 22 is a flowchart showing an example of the read operation of the concealment apparatus 40 in the separation state in the second embodiment (mirroring) of the present invention. With reference to FIG. 22, the following describes the read operation.

When a read request arrives the concealment apparatus 40 from the host 1, the first communication destination switching means 403 transfers the read request to the separation processing means 405 (step S161).

The separation processing means 405 returns an error to the host 1 (step S162).

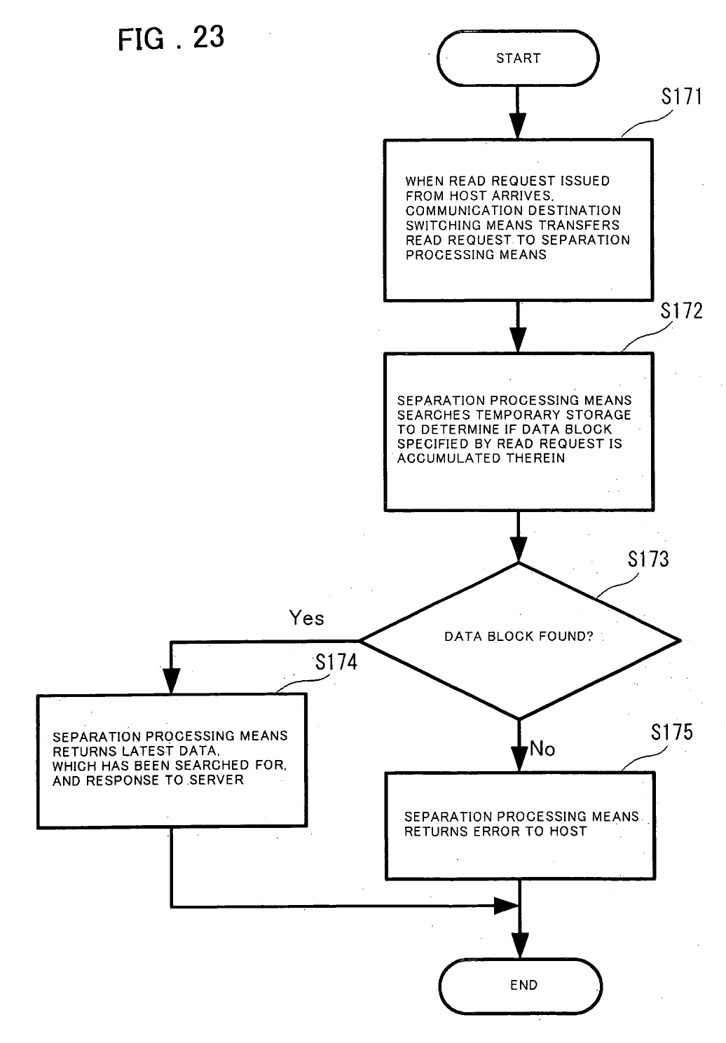

FIG. 23 is a flowchart showing another example of the read operation performed by the concealment apparatus in the separation state in the second embodiment (mirroring) of the present invention.

When a read request issued from the host 1 arrives the concealment apparatus 40, the first communication destination switching means 403 transfers the read request to the separation processing means 405 (step S171).

The separation processing means 405 searches the temporary storage 401 to determine if the data block specified by the read request is stored therein (step S172).

If the specified data block is included in the temporary storage 401 (Yes in step S173), the separation processing means 405 of the concealment apparatus 40 returns the latest data, which has been searched for, and a response to the server (step S174).

If the specified data block is not included, the separation processing means 405 of the concealment apparatus 40 returns an error to the host 1 (step S175).

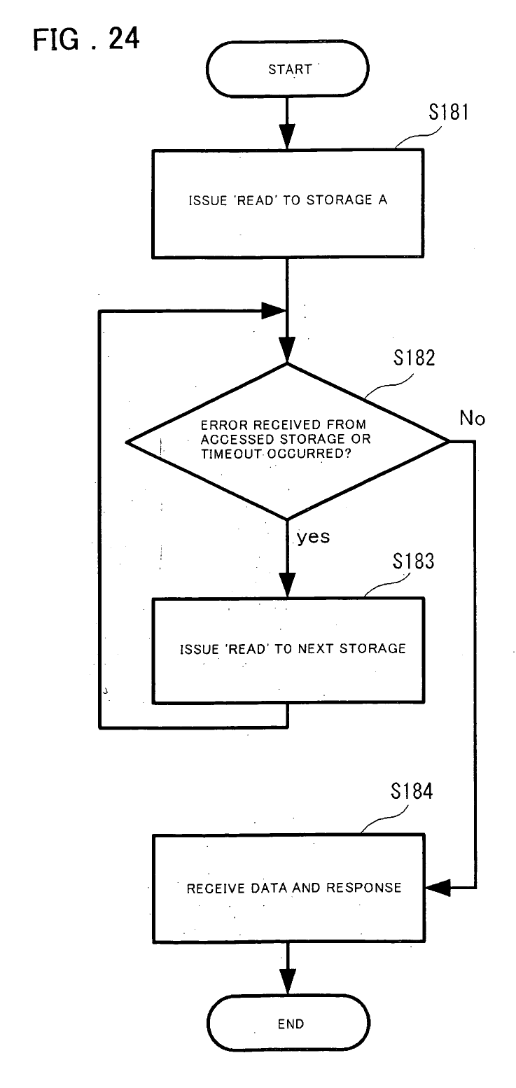

FIG. 24 is a flowchart showing the read operation performed when the transition from separation to resynchronization has occurred in the second embodiment (mirroring) of the present invention. With reference to FIG. 24, the following describes the read operation in the resynchronization state.

The host 1 issues ‘read’ to storage A (step S181).

If data can be read normally from accessed storage, the host 1 receives data and a response (No in step S181, step S184).

If an error is received from the accessed storage or a timeout occurs (Yes in step S181), the host 1 issues a ‘read’ to the next storage (step S183).

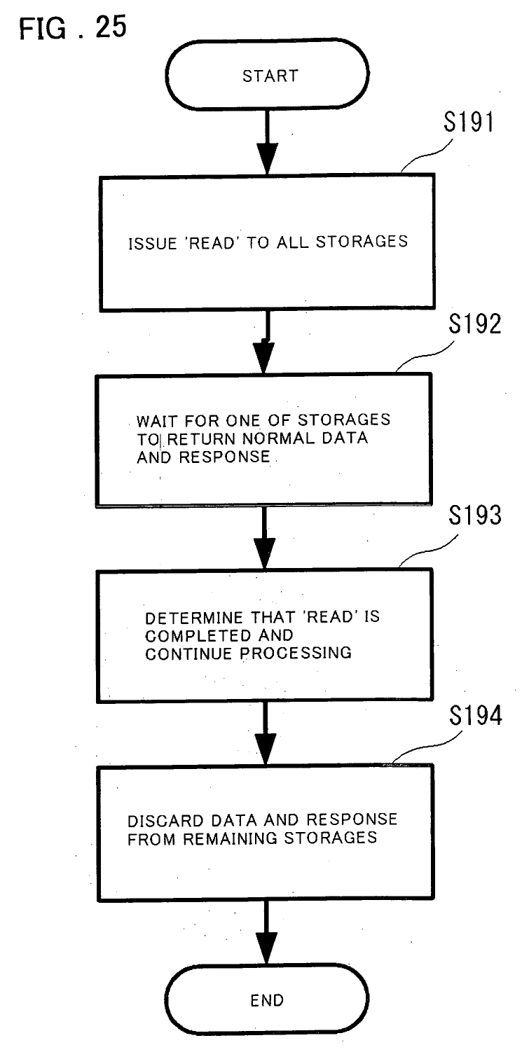

FIG. 25 is a flowchart showing another read operation performed when the transition from separation to resynchronization has occurred in the second embodiment (mirroring) of the present invention. With reference to FIG. 25, the following describes the read operation in the resynchronization state.

The host 1 issues ‘read’ to all storages (storages A and B in FIG. 13) (step S191).

The host 1 waits for one of the storages to return normal data and a response (step S192).

When normal data and a response are received from one of the storages, the host 1 determines that ‘read’ is completed and continues the processing (step S193).

The host 1 discards the data and the response received from the remaining storages (step S194).

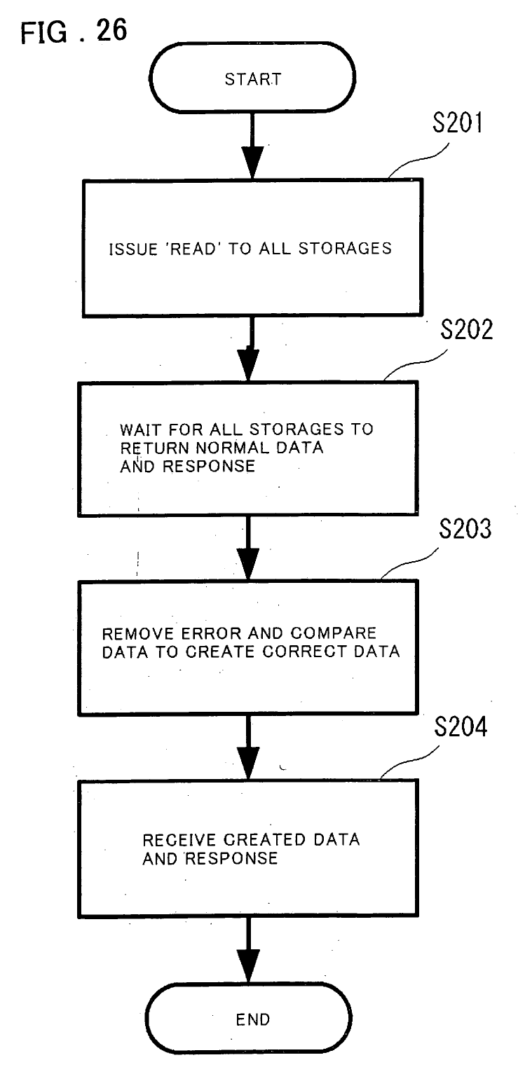

FIG. 26 is a flowchart showing still another mode of processing of the read operation in the resynchronization state in the second embodiment (mirroring) of the present invention. With reference to FIG. 26, the following describes the read operation in the resynchronization state.

The host 1 issues ‘read’ to all storages (step S201).

The host 1 waits for all storages to return normal data and a response (step S202).

Errors are removed, and a comparison is made among data returned by all storages to create correct data (step S203).

The host 1 receives created one piece of data and a response as the read data (step S204).

Note that, if ‘read’ is issued to the storage separated from the concealment apparatus 40, an error is returned to the host 1.

In the example shown in FIG. 24, ‘read’ is issued to another storage if an error occurs during ‘read’ issued to the accessed storage. In the example shown in FIG. 25, the host waits for the next responding storage to return a response if an error is returned from storage that is separated. In the example shown in FIG. 26, the host ignores a response from a separated storage but compares data to create correct data.

If an error is returned from storage to which a read request was issued, no more request may be issued to the storage from which the error was returned until it is determined that the storage is recovered. In a mirroring system where the concealment apparatus is used, at least a write request is issued to storage from which an error was returned. This is to make the best use of the buffering effect.

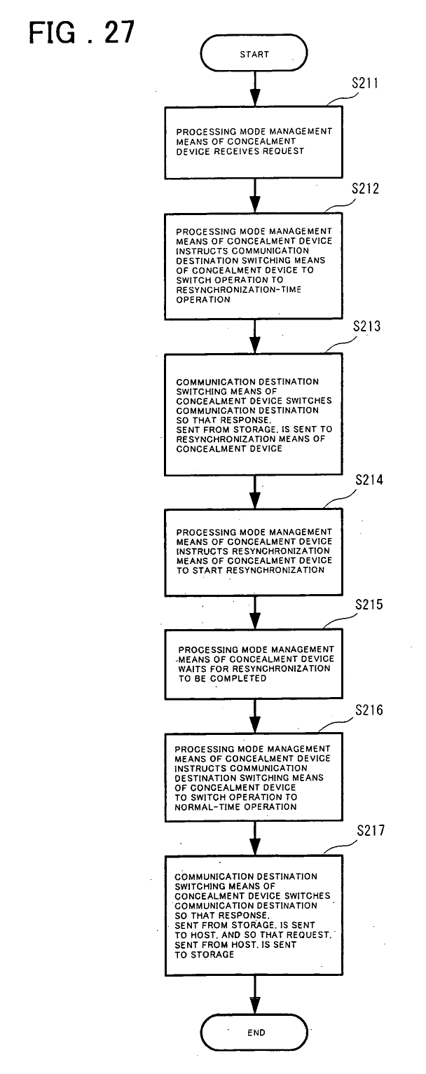

FIG. 27 is a flowchart showing the operation performed when the transition from the resynchronization processing to the normal state occurs in the second embodiment of the present invention. With reference to FIG. 27, the following describes the transition from the resynchronization processing to the normal state.

The processing mode management means 402 of the concealment apparatus 40 receives a resynchronization request (resynchronization instruction) (step S211).

The processing mode management means 402 of the concealment apparatus 40 instructs second communication destination switching means 404 of the concealment apparatus 40 to switch the operation to the resynchronization-time operation (step S212).

The second communication destination switching means 404 of the concealment apparatus 40 switches the communication destination so that a response, sent from storage, is sent to resynchronization means 406 of the concealment apparatus (step S213).

The processing mode management means 402 of the concealment apparatus 40 instructs the resynchronization means 406 of the concealment apparatus 40 to start resynchronization (step S214).

The processing mode management means 402 of the concealment apparatus 40 waits for resynchronization to be completed (step S215). At this time, the processing mode management means 402 monitors the storage amount of data in the temporary storage 401 and, when the storage amount of data in the temporary storage 401 is reduced to zero, decides that the resynchronization is completed.

The processing mode management means 402 of the concealment apparatus 40 instructs the second communication destination switching means 404 of the concealment apparatus 40 to switch the operation to the normal operation (step S216).

The communication destination switching means 404 of the concealment apparatus 40 switches the communication destination so that a response, sent from the storage, is sent to the host 1, and the communication destination switching means 403 of the concealment apparatus 40 switches the communication destination so that a request, sent from the host 1, is sent to the storage (step S217).

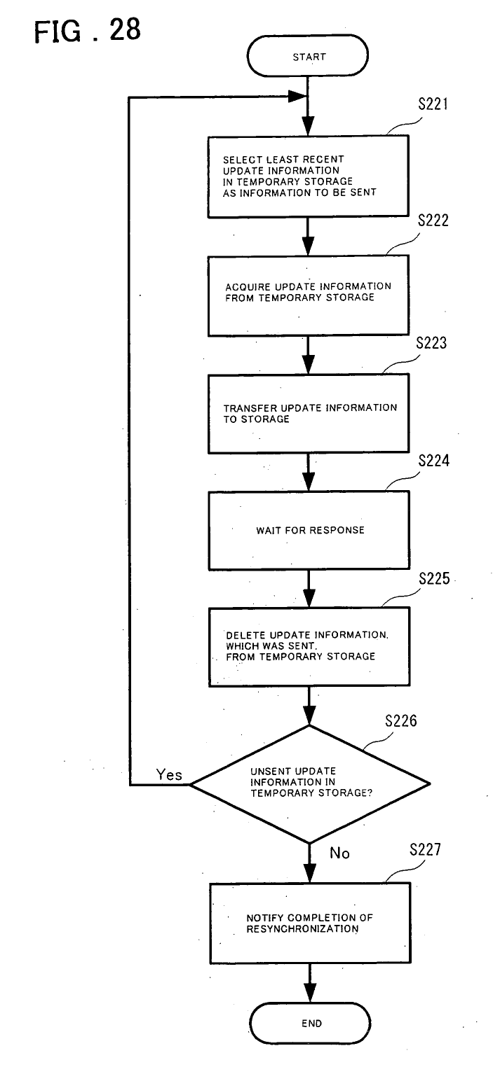

FIG. 28 is a diagram showing the operation of the resynchronization means 406 in the second embodiment of the present invention. With reference to FIG. 28, the following describes the operation of the resynchronization means 406.

The resynchronization means 406 selects the least recent update information from the temporary storage 401 as the information to be sent (step S221).

The resynchronization means 406 acquires the update information from the temporary storage 401 (step S222).

The resynchronization means 406 transfers the update information to the storage (step S223).

The resynchronization means 406 waits for a response from the storage (step S224).

The resynchronization means 406 deletes the update information, which was sent, from the temporary storage 401 (step S225).

If the temporary storage 401 includes unsent update information.(Yes in step S226), control is passed back to step S221; if the temporary storage includes no unsent update information (No in step S226), the resynchronization means 406 notifies the completion of resynchronization (step S227).

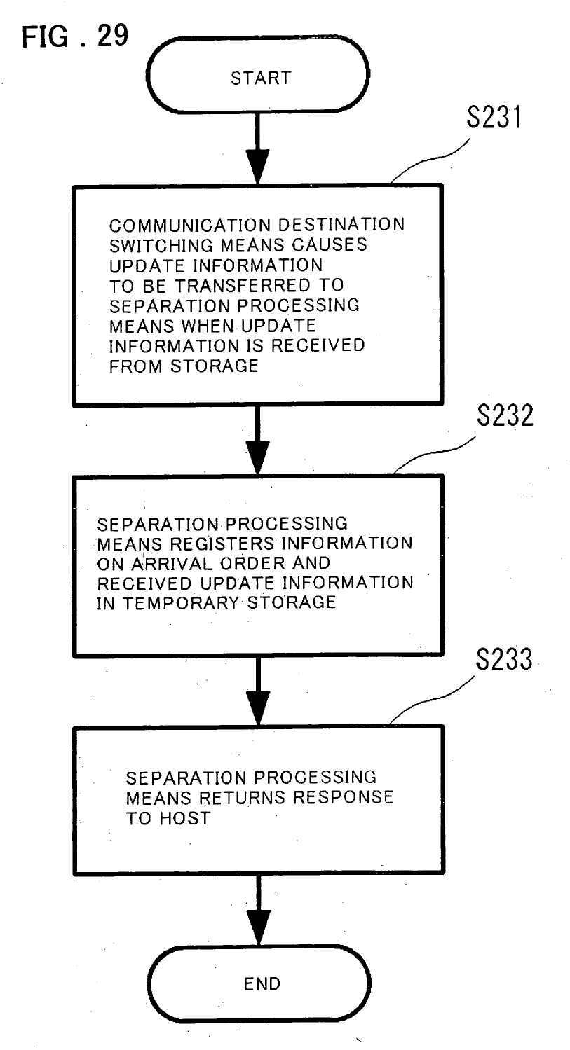

FIG. 29 is a flowchart showing the write operation in the resynchronization state in the second embodiment of the present invention. With reference to FIG. 29, the following describes the write operation performed by the concealment apparatus 40.

When update information is received from the storage, the communication destination switching means 403 of the concealment apparatus 40 causes the received update information to be transferred to the separation processing means 405 (step S231).

The separation processing means 405 registers the information on the arrival order and the received update information in the temporary storage 401 (step S232).

The separation processing means 405 returns a response to the host 1 (step S233).

Until the completion of resynchronization, the transfer of a request by the communication destination switching means 403 is kept waiting, thereby avoiding the occurrence of the condition in which the update information stays long in the temporary storage 401. That is, the writing of update information into the temporary storage 401 is kept waiting until the storage amount of data in the temporary storage 401 is reduced to 0 or is almost equal to 0.

It is also possible to apply a write received in the resynchronization state directly to the storage and, for the already-written data blocks, to stop or discard the transfer of update information to the temporary storage 401. This configuration reduces the amount of data transfer in the resynchronization state and reduces the resynchronization time.

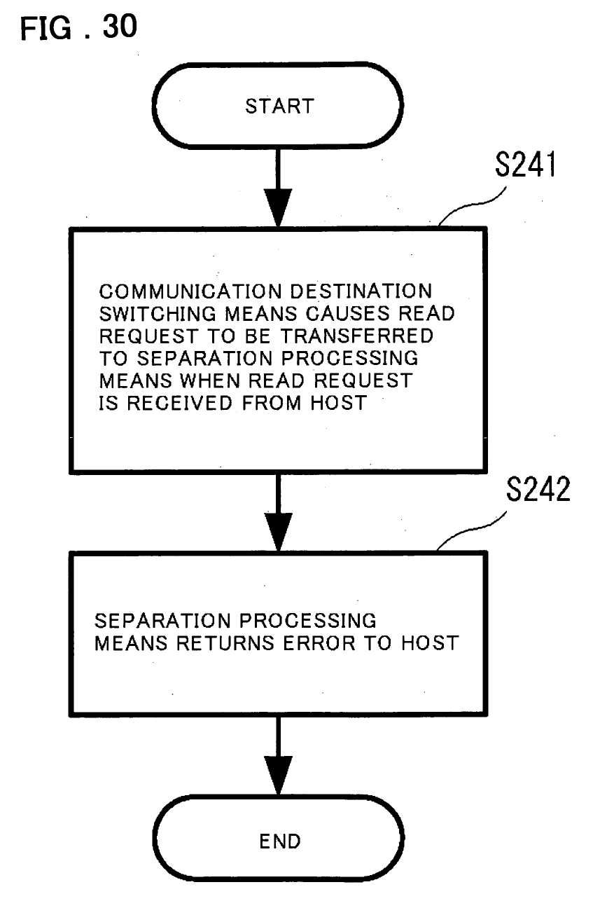

FIG. 30 is a flowchart showing the read operation performed by the concealment apparatus 40 in the resynchronization state in the second embodiment (mirroring) of the present invention. With reference to FIG. 30, the following describes the read operation performed by the concealment apparatus 40 in the resynchronization state.

When a read request is received from the host 1, the communication destination switching means 403 of the concealment apparatus 40 causes the read request to be transferred to the separation processing means 405 (step S241).

The separation processing means 405 returns an error to the host 1 (step S242).

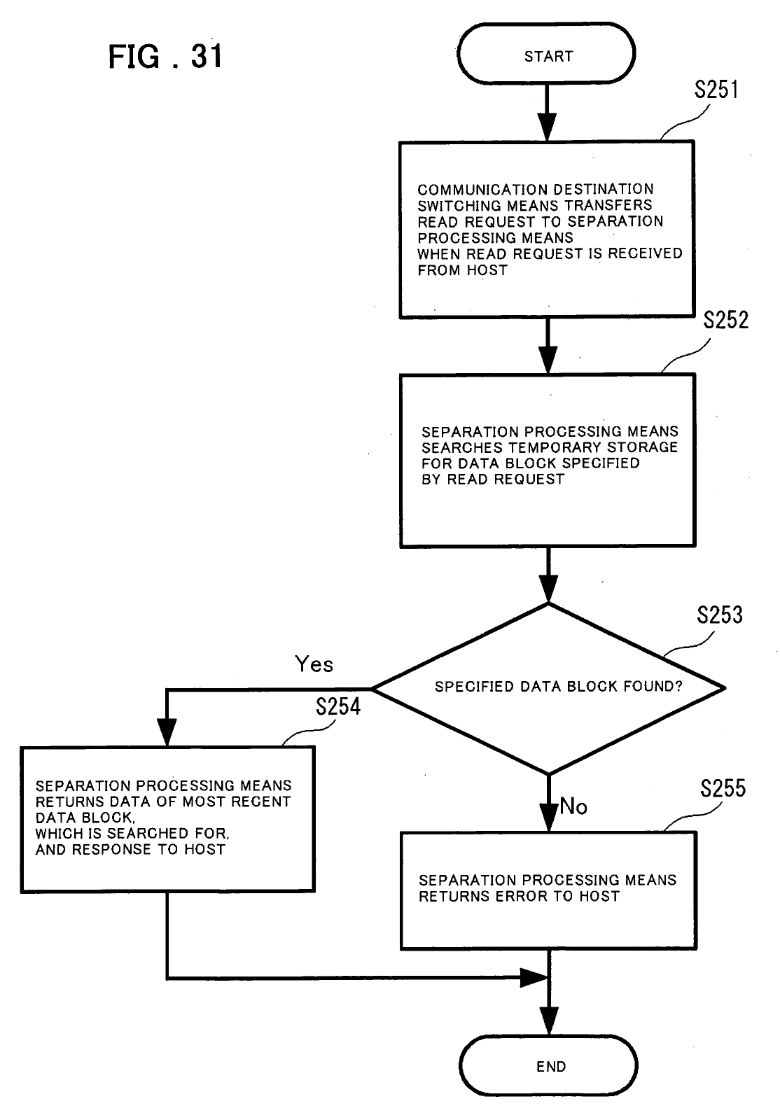

FIG. 31 is a flowchart showing another example of the read operation performed by the concealment apparatus 40 in the resynchronization state in the second embodiment (mirroring) of the present invention. With reference to FIG. 31, the following describes the read operation performed by the concealment apparatus 40 in the resynchronization state.

When a read request is received from the host 1, the communication destination switching means 403 of the concealment apparatus 40 transfers the read request to the separation processing means 405 (step S251).

The separation processing means 405 searches the temporary storage 401 for the data block specified by the read request (step S252).

If the specified data block is found (Yes in step S253), the separation processing means 405 returns the data of the most recent data block, which is searched for, and the response to the host 1 (step S254).

If the specified block is not found (No in step S253), the separation processing means 405 returns an error to the host 1.

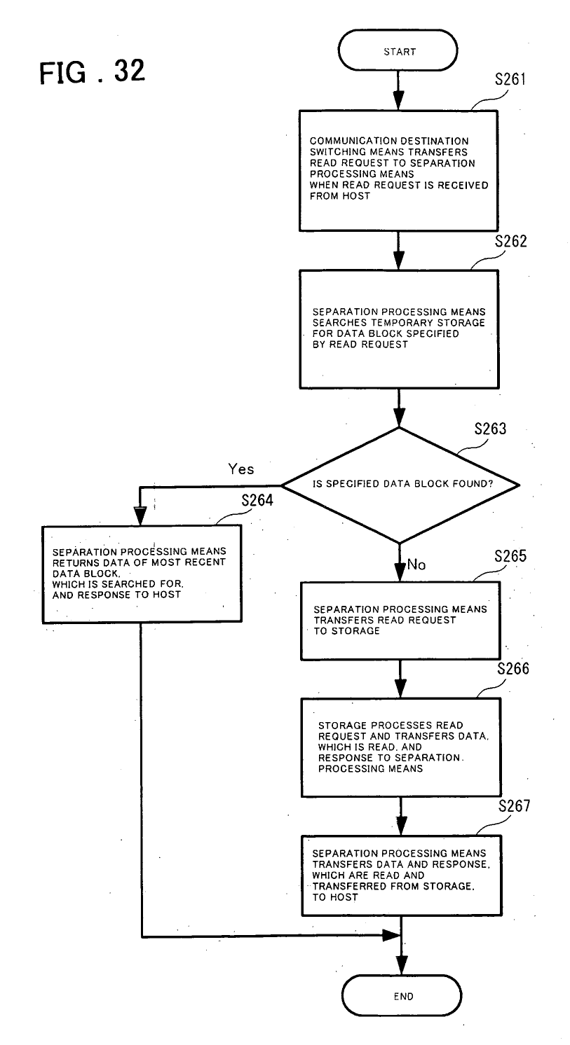

FIG. 32 is a diagram showing the read operation performed by the concealment apparatus 40 in the resynchronization state in the second embodiment (mirroring) of the present invention. With reference to FIG. 32, the following describes still another example of the read operation of the concealment apparatus 40 in the resynchronization state.

When a read request is received from the host 1, the communication destination switching means 403 of the concealment apparatus 40 transfers the read request to the separation processing means 405 (step S261).

The separation processing means 405 searches the temporary storage 401 for the data block specified by the read request (step S262).

If the specified data block is found (Yes in step S263), the separation processing means 405 returns the data of the most recent data block, which is searched for), and the response to the host 1 (step S264).

If the specified data block is not found (No in step S263), the separation processing means 405 transfers the read request to the storage (step S265).

The storage processes the read request and transfers the data, which is read, and the response to the separation processing means 405 (step S266).

The separation processing means 405 transfers the data and the response, which are read and transferred from the storage, to the host 1 (step S267).

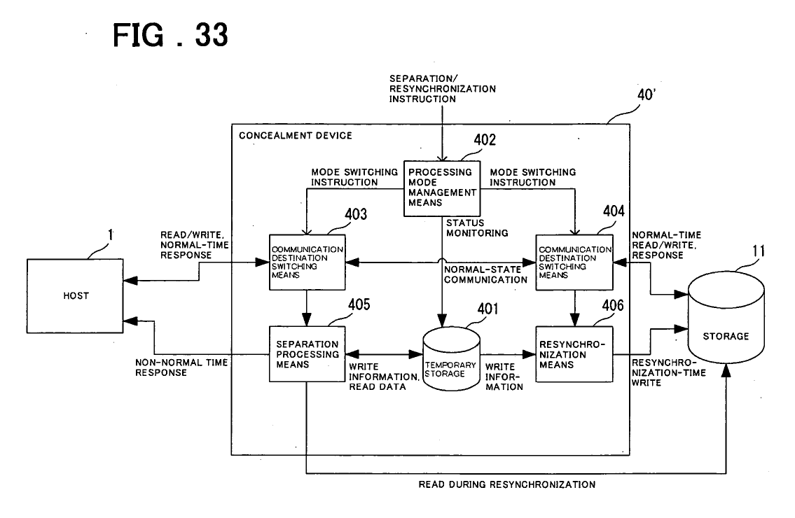

FIG. 33 is a diagram showing the configuration of the second embodiment of the present invention whose operation is described by referring to FIG. 32.

In the concealment apparatus 40′ that receives a read request from the host 1 in the resynchronization state (during execution of resynchronization by the resynchronization means 406), the separation processing means 405 searches the temporary storage 401 for the data block to be read. If the data block is not found in the temporary storage 401, the separation processing means 405 makes a direct access to the storage 11, acquires data, which is read, and the response from the storage 11, and returns them to the host 1.

If the data block is found in the temporary storage 401, the separation processing means 405 reads data from the temporary storage 401 and returns the data and the response to the host 1.

While the present invention has been described with reference to the embodiment above, it is to be understood that the present invention is not limited to the configuration of the embodiments described above and that modifications and changes that may be made by those skilled in the art within the scope of the present invention are included.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A separation concealment apparatus, provided on a transfer path between a data transfer source system and a data transfer destination storage system, and adapted to replace a separation between the data transfer source system and the data transfer destination storage system with a separation between the separation concealment apparatus and the data transfer destination storage system to conceal from said data transfer source system that said data transfer source system and said transfer destination storage system are separated, said apparatus comprising:
a temporary storage device; and
separation processing means for receiving data which is transferred from said data transfer source system to said transfer destination storage system during the separation and for storing the data received in said temporary storage device.

2. The separation concealment apparatus according to claim 1, further comprising:
means for performing resynchronization by transferring the data, stored in said temporary storage device, to said data transfer destination storage system to conceal from said data transfer source system that said data transfer destination storage system is performing resynchronization.

3. The separation concealment apparatus, according to claim 1, wherein said data transfer source system comprises a replication source storage; and said transfer destination storage system comprises a replication destination storage; and wherein a separation between said replication source storage and said replication destination storage is replaced with a separation between said separation concealment apparatus and said replication destination storage to conceal from said replication source storage that said replication source storage and said replication destination storage are separated.

4. The separation concealment apparatus according to claim 3, wherein said separation processing means receives update information, which is transferred from said replication source storage to said replication destination storage and stores the update information in said temporary storage device during the separation.

5. The separation concealment apparatus according to claim 4, further comprising:
resynchronization means for performing resynchronization of said replication destination storage, wherein during the resynchronization, said resynchronization means transfers the update information, stored in said temporary storage device, to said replication destination storage to resynchronize said replication destination storage with no need for said replication source storage to be involved in the resynchronization processing.

6. The separation concealment apparatus according to claim 5, wherein, after the update information stored in said temporary storage device is transferred to said replication destination storage during the resynchronization, said resynchronization means deletes the update information from said temporary storage device.

7. The separation concealment apparatus according to claim 5, further comprising:
monitoring means for monitoring a storage amount of said temporary storage device during the resynchronization; and
means that, when there is left no update information stored in said temporary storage device during the resynchronization, decides that the resynchronization is completed and controls the state of the separation concealment apparatus so as to transition to a normal state.

8. The separation concealment apparatus according to claim 5, wherein, for use when update information is received from said replication source storage during the resynchronization, said separation processing means comprises means for storing the update information and information on an arrival order of the update information in said temporary storage device and for returning a response to said replication source storage.

9. An information processing system including:
the separation concealment apparatus as set fourth in claim 3;
said replication source storage; and
said replication destination storage.

10. An information processing system that performs mirroring in which a host writes the same data in a plurality of storages, comprising:
a plurality of separation concealment apparatuses, each as set fourth in claim 1, and provided on each of respective transfer paths between said host and said plurality of storages;
wherein a separation between said host constituting a data transfer source system and a storage constituting a data transfer destination storage is replaced with a separation between said separation concealment apparatus and said storage to conceal from said host that said host and said storage are separated.

11. The information processing system according to claim 10, wherein said separation processing means of said separation concealment apparatus, upon receiving a write request to said storage and data from said host during the separation, stores the write request and the data in said temporary storage device.

12. The information processing system according to claim 11, wherein, when a read request is received from said host during the separation, said separation processing means of said separation concealment apparatus searches said temporary storage device to check if data specified by the read request is stored,
if the data specified by the read request is stored in said temporary storage device, said separation processing means returns the data, which is searched for, to said host, and
if the data specified by the read request is not stored in said temporary storage device, said separation processing means returns an error to said host.

13. The information processing system according to claim 10, wherein said separation concealment apparatus further comprises means that, when a read request is received from said host during resynchronization, issues a read request to said plurality of storages and, when data and a response are received from at least one of said plurality of storages, decides that read is completed.

14. The information processing system according to claim 11, wherein said separation concealment apparatus further comprises means for transferring a write request and data, stored in said temporary storage device, to said storage during resynchronization.

15. The information processing system according to claim 11, wherein said separation concealment apparatus further comprises means that monitors a storage amount of said temporary storage device during resynchronization; and
means that, when there is left no update information stored in said temporary storage device during resynchronization, decides that the resynchronization is completed and controls the state of the separation concealment apparatus so as to transition to a normal state.

16. A separation control method for use between a data transfer source system and a data transfer destination storage system, comprising the steps of:
providing a separation concealment apparatus, which conceals a separation between the data transfer source system and the data transfer destination storage;
replacing a separation between the data transfer source system and the data transfer destination storage by a separation between said separation concealment apparatus and said data transfer destination storage system; and
storing, by said separation concealment apparatus, update information, transferred from said data transfer source system to said data transfer destination storage system during the separation, in a temporary storage device to thereby conceal the separation between said data transfer source system and said data transfer destination storage system from said data transfer source system.

17. The method according to claim 16, wherein said data transfer source system is a host performing mirroring in which the same data from the host is written in a plurality of storages, said method comprising the steps of:
providing a plurality of separation concealment apparatuses, each provided between said host and each of said plurality of storages;
replacing a separation between said host and said storage by a separation between said separation concealment apparatus and said storage; and
when a write request to said storage and data are received from said host during the separation, storing, by said separation concealment apparatus, the write request and the data in a temporary storage device to thereby conceal the separation between said host and said storage from said host.

18. A computer program causing a computer, which constitutes a separation concealment apparatus provided between a data transfer source system and a data transfer destination storage system to conceal a separation, to execute:
the processing of receiving update information, which is transferred from said data transfer source system to said data transfer destination storage during the separation, to store the update information in a temporary storage device to thereby conceal the separation between said data transfer source system and said data transfer destination storage from said data transfer source system.

19. The computer program according to claim 18, wherein said data transfer source system is a host performing mirroring in which the same data from the host is written in a plurality of storages, each being a data transfer destination storage, said program causing a computer of each of a plurality of separation concealment apparatuses, each provided between a host and each of said plurality of storages to conceal a separation, said program causing said computer to execute:
the processing of storing a write request and data received from said host into a temporary storage device during the separation to conceal the separation between said host and said storage from said host.
